(19) United States
(12) Patent Application Publication
(10) Pub. No.: US 2025/0192148 A1
(43) Pub. Date: Jun. 12, 2025

(54) POSITIVE-ELECTRODE ACTIVE MATERIAL FOR LITHIUM-ION SECONDARY BATTERY, POSITIVE ELECTRODE, LITHIUM-ION SECONDARY BATTERY, AND METHOD FOR MANUFACTURING POSITIVE-ELECTRODE ACTIVE MATERIAL FOR LITHIUM-ION SECONDARY BATTERY

(71) Applicant: SHINSHU UNIVERSITY, Matsumoto City, Nagano (JP)

(72) Inventors: Nobuyuki ZETTSU, Nagano City, Nagano (JP); Katsuya TESHIMA, Nagano City, Nagano (JP); Takumi KONDO, Nagano City, Nagano (JP)

(21) Appl. No.: 18/550,491

(22) PCT Filed: Mar. 17, 2022
(86) PCT No.: PCT/JP2022/012424

§ 371 Date: Nov. 8, 2024

(30) Foreign Application Priority Data
Mar. 18, 2021 (JP) 2021-044282

(51) Int. Cl. H01M 4/36; H01M 4/02; H01M 4/04; H01M 4/1315; H01M 4/505; H01M 4/525; H01M 4/58; H01M 10/0525

(52) U.S. Cl. CPC H01M 4/366; H01M 4/0471; H01M 4/1315; H01M 4/505; H01M 4/525; H01M 4/582; H01M 10/0525; H01M 2004/028

(57) ABSTRACT

Provided is a positive-electrode active material for a lithium-ion secondary battery able to achieve an even higher capacity, improved cycle characteristics and discharge characteristics, and a low cost.

The positive-electrode active material 11 for a lithium-ion secondary battery has a fluoride layer 11b which coats at least part of a core particle 11a and is formed of fluoride of the lithium metal composite oxide. The lithium metal composite oxide of the core particle 11a is represented by LiNiₖCoₗMnₘO₂ (k+1+m=1, k≥0.6). In addition, the fluoride of the lithium metal composite oxide of the fluoride layer 11b is represented by Li_{1-z}NiₖCoₗMnₘO₂₋ₓFₓ (k+1+m=1, k≥0.6, z≤0.62, 0<x≤1).

### TECHNICAL FIELD

The present invention relates to a positive-electrode active material for a lithium-ion secondary battery, a positive electrode, a lithium-ion secondary battery, and a method for manufacturing a positive-electrode active material for a lithium-ion secondary battery.

Priority is claimed on Japanese Patent Application No. 2021-044282, filed Mar. 18, 2021, the content of which is incorporated herein by reference.

### BACKGROUND ART

In recent years, non-aqueous electrolytic solution-based secondary batteries such as lithium-ion batteries, which were proposed as batteries anticipated to be smaller and lighter and have higher capacities, have been put into practical use. Such lithium-ion batteries are formed of a positive electrode and a negative electrode, which have the property of enabling the reversible insertion and removal of lithium-ions, and a non-aqueous electrolyte.

A lithium metal composite oxide is used as a positive-electrode active material for lithium secondary batteries. Lithium secondary batteries are already in practical use as compact power sources for mobile phone applications, notebook computer applications, and the like. Furthermore, efforts are also underway to apply such batteries to medium-sized and large-sized power sources for automotive applications, power storage applications, and the like. With this expansion of the range of applications, extending the lifespan of lithium secondary batteries is an important issue.

Lithium metal composite oxides used as a positive-electrode active material for a lithium-ion secondary battery include, for example, NCM-type composite oxides including lithium, nickel, cobalt, manganese, and oxygen. In particular, NCM-type lithium composite oxides having a high nickel content blended therein have a high capacity and a high thermal stability and are low cost and are thus being increasingly applied to large batteries, with further efforts being underway to increase the capacity and improve the cycle characteristics and discharge characteristics thereof.

In general, lithium composite oxides used as positive-electrode active materials include, in addition to NCM-type composite oxides, for example, LNMO-type composite oxides including lithium, nickel, manganese, and oxygen. Although these LNMO-type composite oxides have the advantage of being usable at high potential, there is a problem in that metal elements are eluted into the electrolytic solution during operation at a high potential, causing battery deterioration. Therefore, an electrode was proposed in which a coating layer of a water-repellent material is provided on the surface of an electrode active material (Patent Document 1).

In addition, proposals for modifications of the surface of an electrode active material include a positive-electrode active material in which the surface of a lithium cobalt composite oxide is covered with Y₂O₃ or Li₂YO₃ in order to achieve a high operating voltage, excellent charge/discharge characteristics, and storage characteristics (Patent Document 2) and a positive-electrode active material in which a hydroxide or oxyhydroxide of a rare earth element such as Y is fixed to the surface of a lithium transition metal composite oxide such as a lithium cobalt composite oxide for the purpose of suppressing capacity decreases (Patent Document 3).

### CITATION LIST

### Patent Documents

### [Patent Document 1]

Japanese Unexamined Patent Application, First Publication No. 2017-174692

### [Patent Document 2]

Japanese Unexamined Patent Application, First Publication No. H05-06780

### [Patent Document 3]

Japanese Unexamined Patent Application, First Publication No. 2011-141989

### SUMMARY OF INVENTION

### Technical Problem

However, the Patent Documents described above do not disclose modifying the surface of a highly nickel-based NCM-type composite oxide or disclose the specific configuration of the coating portion formed on the surface of the composite oxide and there is still room for improvement in terms of improving the characteristics of lithium-ion secondary batteries using NCM-type composite oxides.

The present invention has an object of providing a positive-electrode active material for a lithium-ion secondary battery able to achieve an even higher capacity, improved cycle characteristics and discharge characteristics, and a low cost, a positive electrode, a lithium-ion secondary battery, and a method for manufacturing a positive-electrode active material for a lithium-ion secondary battery.

### Solution to Problem

As a result of extensive research, the present inventors found that forming a fluoride of a highly nickel-based NCM-type composite oxide on the surface or near the surface of a positive-electrode active material for a lithium-ion secondary battery formed of the composite oxide makes it possible to make a solid electrolyte interface layer (also referred to below as a CEI layer) formed during charge/discharge cycles thinner, additionally, making the CEI layer thinner suppresses high resistance to lithium-ion transporting at the electrolytic solution interface and electron conduction within the positive-electrode active material, while solving the contradictory issues of surface stabilization using the CEI layer and suppressing high resistance makes it possible to realize an even higher capacity and improve the cycle characteristics and discharge characteristics.

That is, the present invention provides the configurations described below.

[1]A positive-electrode active material for a lithium-ion secondary battery including a core particle formed of a lithium metal composite oxide, and a fluoride layer which coats at least part of the core particle and is formed of a fluoride of the lithium metal composite oxide, in which the lithium metal composite oxide is represented by LiNiₖCoₗMnₘO₂(k+l+m=1, k≥0.6), and the fluoride of the lithium metal composite oxide is represented by Li_{1-z}NiₖCoₗMnₘO₂₋ₓFₓ (k+l+m=1, k≥0.6, z≤0.62, 0<x≤1).

[2] The positive-electrode active material for a lithium-ion secondary battery according to [1] described above, in which the fluoride layer contains lithium fluoride.

[3] The positive-electrode active material for a lithium-ion secondary battery according to [1] or [2] described above, in which an atomic concentration ratio of fluorine atoms to oxygen atoms in the fluoride layer has a concentration gradient that decreases from an outer surface toward an inner part of the positive-electrode active material for a lithium-ion secondary battery.

[4] The positive-electrode active material for a lithium-ion secondary battery according to [1] or [2] described above, in which the fluoride of the lithium metal composite oxide has a layered rock salt-type structure, and fluorine atoms are coordinated between adjacent transition metal layers of the layered rock salt-type structure.

[5] The positive-electrode active material for a lithium-ion secondary battery according to any one of [1] to [3] described above, in which an atomic concentration ratio of fluorine atoms to oxygen atoms in the fluoride layer is 0.1% or more in a depth range of 0 to 50 nm from the outer surface of the positive-electrode active material for a lithium-ion secondary battery.

[6] The positive-electrode active material for a lithium-ion secondary battery according to [5] described above, in which the atomic concentration ratio of fluorine atoms to oxygen atoms in the fluoride layer is 0.01 or more and 0.08 or less in a depth range of 50 to 100 nm from the outer surface of the positive-electrode active material for a lithium-ion secondary battery.

[7] The positive-electrode active material for a lithium-ion secondary battery according to any of [1] to [4] described above, in which the lithium metal composite oxide is represented by LiNi_{0.8}Co_{0.1}Mn_{0.1}O₂, and the fluoride of the lithium metal composite oxide is represented by Li_{1-z}Ni_{0.8}Co_{0.1}Mn_{0.1}O₂₋ₓFₓ (z≤0.62, 0<x≤1).

[8]A positive electrode for a lithium-ion secondary battery including a positive electrode current collector, and a positive-electrode active material-containing layer containing the positive-electrode active material for a lithium-ion secondary battery according to any one of [1] to [7] described above, which is provided on the positive electrode current collector.

[9]A lithium-ion secondary battery including the positive electrode for a lithium-ion secondary battery according to [8] described above, a negative electrode, and an electrolyte.

[10]A method for manufacturing a positive-electrode active material for a lithium-ion secondary battery, the method including a step of placing a rare gas fluoride and a lithium metal composite oxide in a sealed space and forming a fluoride layer formed of a fluoride of the lithium metal composite oxide on the lithium metal composite oxide.

[11] The method for manufacturing a positive-electrode active material for a lithium-ion secondary battery according to [10] described above, further including a step of heat treating the lithium metal composite oxide on which the fluoride layer is formed after the step of forming the fluoride layer.

[12] The method for manufacturing a positive-electrode active material for a lithium-ion secondary battery according to [10] described above, in which the lithium metal composite oxide on which the fluoride layer is formed is heat treated at 300° C. to 1000° C. for 3 hours to 10 hours.

### Advantageous Effects of Invention

According to the present invention, it is possible to provide a positive-electrode active material for a lithium-ion secondary battery able to achieve an even higher capacity, improved cycle characteristics and discharge characteristics, and a low cost, a positive electrode, a lithium-ion secondary battery, and a method for manufacturing a positive-electrode active material for a lithium-ion secondary battery.

### BRIEF DESCRIPTION OF DRAWINGS

FIG. 1(a) is an electron microscope image showing the external appearance of a positive-electrode active material for a lithium-ion secondary battery according to the present embodiment and FIG. 1(b) is a schematic diagram showing the configuration of the positive-electrode active material for a lithium-ion secondary battery.

FIG. 2(a) and FIG. 2(b) are schematic diagrams showing the layered rock salt-type structure of a fluoride of NCM811 as an example of a fluoride of a lithium metal composite oxide.

FIG. 3 is a schematic diagram conceptually showing the difference in lattice volume change between a positive-electrode active material for a lithium-ion secondary battery of the related art that does not have a fluoride layer and the positive-electrode active material for a lithium-ion secondary battery according to the present embodiment.

FIG. 4(a) is a graph showing lattice volume change during a lithium-ion desorption reaction process and FIG. 4(b) is a schematic diagram for showing the mechanism of suppressing the lattice volume change in the fluoride of the lithium metal composite oxide.

FIG. 5 is a diagram showing an example of a specific configuration of a lithium-ion secondary battery according to an embodiment of the present invention.

FIG. 6(a) to FIG. 6(d) are electron microscope images showing the external appearance of positive-electrode active materials for a lithium-ion secondary battery in Examples 1 to 3 and Comparative Example 1.

FIG. 7 is a diagram showing XRD patterns of positive-electrode active materials for a lithium-ion secondary battery in Examples 1 to 3 and Comparative Example 1.

FIG. 8(a) is a diagram showing XPS spectra of fluorine atoms (1s) in the positive-electrode active materials for a lithium-ion secondary battery in Examples 1 to 3 and Comparative Example 1 and FIG. 8(b) is a diagram showing peaks attributed to transition metal-fluorine bonds and peaks attributed to lithium fluoride in Examples 1 to 3.

FIG. 9(a) and FIG. 9(b) are diagrams showing XPS spectra of the nickel element (2p) in the positive-electrode active materials for a lithium-ion secondary battery in Examples 1 to 3 and Comparative Example 1.

FIG. 10(a) and FIG. 10(b) are diagrams showing XPS spectra of the manganese element (2p) in the positive-electrode active materials for a lithium-ion secondary battery in Examples 1 to 3 and Comparative Example 1.

FIG. 11 is a diagram showing XPS spectra of the cobalt element (2p) in the positive-electrode active materials for a lithium-ion secondary battery in Examples 1 to 3 and Comparative Example 1.

FIG. 12 is a diagram showing initial charge/discharge curves of cycle tests in Examples 1 to 3 and Comparative Example 1.

FIG. 13(a) is a diagram showing changes in discharge capacity in cycle tests in Examples 1 to 3 and Comparative Example 1 and FIG. 13(b) is a diagram showing changes in discharge capacity retention rate.

FIG. 14(a) is a schematic diagram showing the solution resistance, CEI layer resistance, and charge transfer resistance at the positive electrode in Examples 1 to 3 and Comparative Example 1 and FIG. 14(b) is a graph showing the impedance after one cycle of the cycle test.

FIG. 15 is a graph showing the impedance after 200 cycles of the cycle test in Examples 1 to 3 and Comparative Example 1.

FIG. 16(a) is a diagram showing changes in the discharge capacity in rate characteristic tests in Examples 1 to 3 and Comparative Example 1 and FIG. 16(b) is a diagram showing changes in the discharge capacity retention rate.

FIG. 17 is a graph showing UPS analysis results in Examples 1 to 3 and Comparative Example 1.

FIG. 18(a) to FIG. 18(c) are graphs showing changes in the content of each atomic concentration in relation to the direction from the outer surface to the inner part of the positive-electrode active materials in Examples 1 to 3 and FIG. 18(d) is a graph showing changes in the concentration of fluorine atoms with respect to oxygen atoms in relation to the direction described above in Example 1.

FIG. 19(a) is a diagram showing the measurement results of cyclic voltammetry (CV) in Comparative Example 1 and FIG. 19(b) is a diagram showing the measurement results of cyclic voltammetry (CV) in Example 1.

FIG. 20(a) is a diagram comparing cyclic voltammetry (CV) in Example 1 and Comparative Example 1, FIG. 20(b) is a diagram showing the relationship between the sweep speed and peak current in Comparative Example 1, and FIG. 20(c) is a diagram showing the relationship between the sweep speed and the peak current in Example 1.

FIG. 21(a) is a diagram showing changes in discharge capacity in cycle tests under high rate conditions in Example 1 and Comparative Example 1 and FIG. 21(b) is a diagram showing changes in the discharge capacity retention rate.

FIG. 22(a) is a diagram showing changes in discharge capacity in a cycle test under high potential conditions in Examples 1 to 3 and Comparative Example 1 and FIG. 22(b) is a diagram showing changes in the discharge capacity retention rate.

FIG. 23(a) is a diagram showing changes in the discharge capacity in a rate characteristic test under high potential conditions in Example 1 and Comparative Example 1 and FIG. 23(b) is a diagram showing changes in the discharge capacity retention rate.

FIG. 24(a) is a diagram showing the measurement results of cyclic voltammetry (CV) in a first cycle under high potential conditions in Example 1 and Comparative Example 1 and FIG. 24(b) is a diagram showing the measurement results of cyclic voltammetry (CV) in the fifth cycle.

FIG. 25(a) is a diagram showing a lithium-ion diffusion coefficient (D_{Li}) with respect to an open circuit voltage obtained from GITT measurement and FIG. 25(b) is a diagram showing the lithium-ion diffusion coefficient with respect to the lithium composition (Li_{1-z}Ni_{0.8}Co_{0.1}Mn_{0.1}O₂₋ₓFₓ: 0<z<0.8, x=0.8).

FIG. 26(a) is a diagram showing the c-axis length with respect to a lithium composition obtained from Ex-situ XRD measurement and FIG. 26(b) is a diagram showing the lithium-ion diffusion coefficient with respect to a lithium composition (Li_{1-z}Ni_{0.8}Co_{0.1}Mn_{0.1}O₂₋ₓFₓ: 0<z<0.8, x=0.8) obtained from GITT measurement.

FIG. 27 is a diagram showing the results of performing XPS analysis of the positive-electrode active materials in Examples 4 to 5 and Comparative Example 2, and changes in the valence band spectra before and after fluoride ion replacement.

FIG. 28 is a diagram showing the results of performing UPS measurement on the surface of the positive-electrode active material in Examples 4 to 5 and Comparative Example 2 and evaluating the work function of the positive-electrode active material.

FIG. 29 is a diagram showing the results of evaluating the cycle characteristics at 200 cycles in Examples 4 to 5 and Comparative Example 2.

FIG. 30(a) is a diagram showing an equivalent circuit model used for frequency response analysis in Examples 4 to 5 and Comparative Example 2 and FIG. 30(b) is a diagram showing a Nyquist plot obtained from a full coin cell before the cycle test (open circuit voltage)

FIG. 31(a) is a diagram showing an equivalent circuit model used for frequency response analysis in Examples 4 to 5 and Comparative Example 2 and FIG. 31(b) is a diagram showing a Nyquist plot obtained from a full coin cell after 100 cycles.

FIG. 32(a) is a diagram showing XPS-C1s core level spectra of Examples 4 and 5 and Comparative Example 2 before waveform separation and FIG. 32(b) to 32(d) are diagrams showing XPS-C1s core level spectra of Comparative Example 2, Example 4, and Example 5 after waveform separation.

FIG. 33 is a diagram showing PS-P2p core level spectra of Examples 4 to 5 and Comparative Example 2.

FIG. 34(a) to 34(c) are electron microscope images showing the external appearance of the positive-electrode active materials for a lithium-ion secondary battery in Examples 6 to 8.

FIG. 35(a) is a diagram showing the lithium-ion diffusion coefficient (D_{Li}) during charging with respect to an open circuit voltage obtained from GITT measurement and FIG. 35(b) is a diagram showing the lithium-ion diffusion coefficient (D_{Li}) during discharging.

FIG. 36 is a graph showing changes in the concentration of fluorine atoms with respect to oxygen atoms in relation to the direction from the outer surface to the inner part of the positive-electrode active material in Example 7.

### DESCRIPTION OF EMBODIMENTS

A detailed description will be given below of embodiments of the present invention with reference to the drawings.

### [Configuration of Positive-Electrode Active Material for Lithium-Ion Secondary Battery]

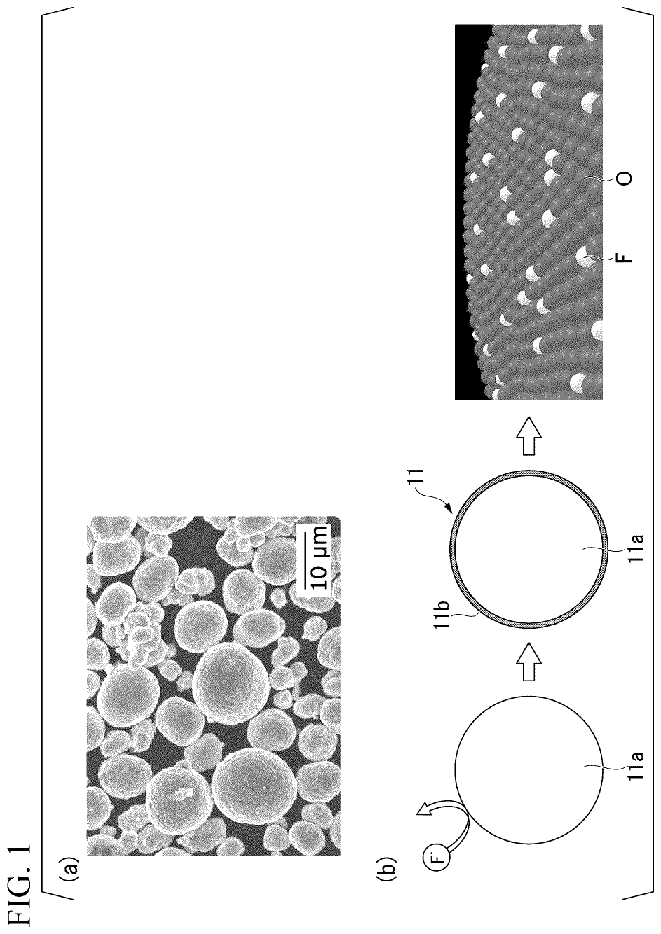

FIG. 1(a) is an electron microscope image showing the external appearance of a positive-electrode active material for a lithium-ion secondary battery according to the present embodiment and FIG. 1(b) is a schematic diagram showing the configuration of the positive-electrode active material for a lithium-ion secondary battery.

As shown in the above diagrams, a positive-electrode active material 11 for a lithium-ion secondary battery includes core particles 11a, which are formed of a lithium metal composite oxide, and a fluoride layer 11b which coats at least a part of the core particles 11a and which is formed of a fluoride of the lithium metal composite oxide.

The lithium metal composite oxide of the core particles 11a is represented by LiNiₖCoₗMnₘO₂(k+l+m=1, k≥0.6). In addition, the fluoride of the lithium metal composite oxide of the fluoride layer 11b is represented by Li_{1-z}NiₖCoₗMnₘO₂₋ₓFₓ (k+1+m=1, k≥0.6, z≤0.62, 0<x≤1).

The lithium metal composite oxide of the core particles 11a is preferably represented by LiNi_{0.8}Co_{0.1}Mn_{0.1}O₂(also referred to below as NCM811) and the fluoride of the lithium metal composite oxide of the fluoride layer 11b is preferably represented by Li_{1-z}Ni_{0.8}Co_{0.1}Mn_{0.1}O₂₋ₓFₓ (z≤0.62, 0<x≤1).

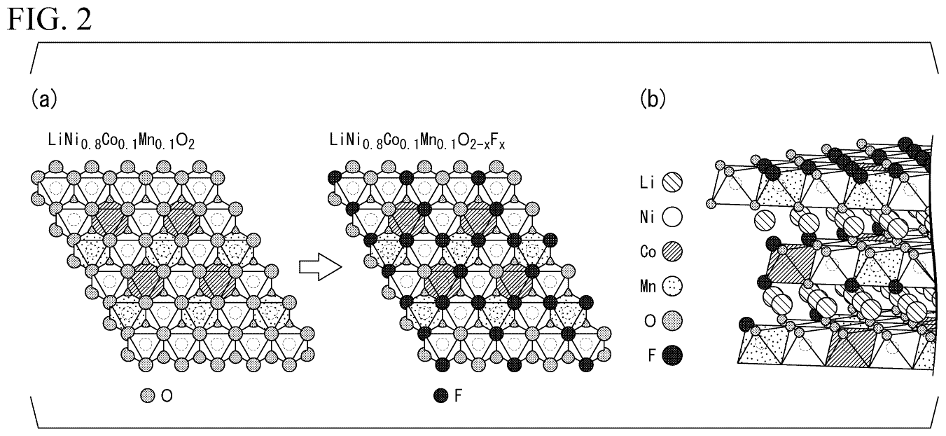

FIG. 2(a) and FIG. 2(b) are schematic diagrams showing the layered rock salt-type structure of a fluoride of NCM811 as an example of a fluoride of a lithium metal composite oxide. As shown in the above diagrams, the fluoride of the lithium metal composite oxide of the fluoride layer 11b has, in common with the core particles 11a, the feature of having a basic crystal structure of a lithium metal composite oxide, but differs in the feature that some of the oxygen ions in the crystal structure are replaced with fluorine ions. In this manner, a part of the crystal structure of the lithium metal composite oxide is modified and the covalent bond between the transition metal and oxygen in the crystal structure of the lithium metal composite oxide is changed to an ionic bond between the transition metal and fluorine, such that a valence band (VB) level is decreased, the fluoride layer 11b is made thinner than the coating portions of the related art, the crystal structure itself is stabilized, and good lithium-ion conduction becomes possible while suppressing the decomposition of the electrolytic solution and the elution of metal elements such as Ni.

The fluoride layer 11b may form a coating layer covering the surface of the core particles 11a, as shown in FIG. 1(b). This coating layer may also be called a CEI layer, which is thinner than a solid electrolyte interface layer (CEI layer) of the related art. The coating layer may cover a part of the surface of the core particles 11a or may cover the entire surface of the core particles 11a.

The thickness of the fluoride layer 11b is, for example, preferably 0.5 nm or more and 10,000 nm or less from the viewpoint of sufficiently exhibiting the above action and effects in a well-balanced manner, more preferably 1 nm or more and 7,000 nm or less, and even more preferably 2 nm or more and 5,000 nm or less.

The fluoride layer 11b may be a portion formed by performing a heat treatment on the lithium metal composite oxide on which the fluoride layer is formed in the manufacturing method described below or may be a portion formed without performing the heat treatment described above.

In a case where the heat treatment step described below is not performed, the thickness of the fluoride layer 11b is, for example, preferably 0.5 nm or more and 100 nm or less, more preferably 1 nm or more and 50 nm or less, and even more preferably 2 nm or more and 20 nm or less.

In a case where the heat treatment step described below is performed, the thickness of the fluoride layer 11b is, for example, preferably 0.5 nm or more and 10,000 nm or less, more preferably 1 nm or more and 7,000 nm or less, and even more preferably 2 nm or more and 5,000 nm or less. In this manner, in a case where the heat treatment step described below is performed, it is possible to increase the thickness of the fluoride layer 11b.

The fluoride layer 11b may further contain lithium fluoride (LiF). In such a case, the amount of fluorine atoms contained in the fluoride layer 11b is the total amount of the fluorine atoms forming the ionic bond between the transition metal and fluorine and the fluorine atoms forming the lithium fluoride.

The atomic concentration ratio of fluorine atoms to oxygen atoms in the fluoride layer 11b decreases from the outer surface to the inner part of the positive-electrode active material 11 for a lithium-ion secondary battery. Due to this, it is possible to suppress electron emissions to suppress the occurrence of side reactions and better lithium-ion conduction becomes possible.

The fluoride layer 11b may have a concentration gradient indicating the amount of decrease in the concentration ratio of fluorine atoms to oxygen atoms in the depth direction from the outer surface of the positive-electrode active material 11 for a lithium-ion secondary battery. It is possible to determine this concentration gradient, for example, as the slope of the tangent to the approximate curve obtained by the method of least squares or the like. In addition, in the manufacturing method described below, the concentration gradient at a certain depth position in the heat treated fluoride layer 11b is preferably smaller than the concentration gradient at the same depth position in the fluoride layer 11b which was not heat treated. In addition, in the case of the fluoride layer 11b which was not heat treated, the above atomic concentration ratio becomes substantially 0 at a certain depth position (for example, 100 nm), but in the case of the heat treated fluoride layer 11b, a constant atomic concentration ratio (for example, 0.05) is maintained even at a certain depth position (for example, 100 nm).

From the viewpoint of the action and effects described above, the atomic concentration ratio of fluorine atoms to oxygen atoms in the fluoride layer 11b is preferably 0.03 or more and 0.5 or less in a depth range of 0 to 50 nm from the outer surface of the positive-electrode active material 11 for a lithium-ion secondary battery and more preferably 0.05 or more and 0.25 or less. In addition, in the depth range of 50 to 100 nm from the outer surface of the positive-electrode active material 11 for a lithium-ion secondary battery, 0.01 or more and 0.08 or less is preferable and 0.04 or more and 0.06 or less is more preferable.

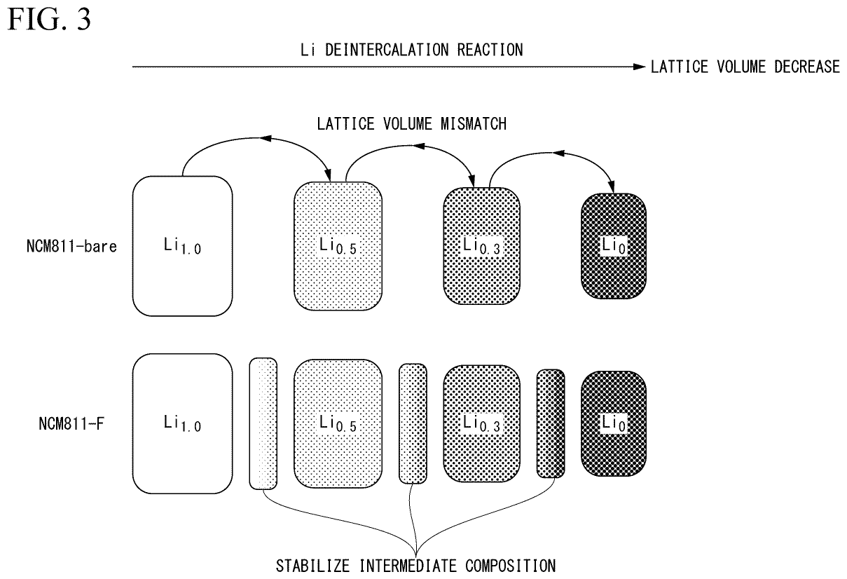

FIG. 3 is a schematic diagram conceptually showing the difference in lattice volume change between a positive-electrode active material for a lithium-ion secondary battery of the related art, which does not have a fluoride layer, and the positive-electrode active material for a lithium-ion secondary battery according to the present embodiment. For example, in NCM811 that does not have a fluoride layer (also referred to below simply as NCM811-bare), which is an example of a positive-electrode active material for a lithium-ion secondary battery of the related art, the volume of the crystal lattice decreases when lithium-ions are desorbed from the lithium metal composite oxide due to a desorption reaction (deintercalation reaction) during discharging. At this time, due to the stability of the crystal structure, the lithium element forming the lithium metal composite oxide transitions to take a predetermined value (1−z=1.0→0.5→0.3→0), thus, the lattice volume of the lithium metal composite oxide decreases stepwise and lattice volume mismatch occurs in transitions before and after the stable state, leading to deterioration of the crystal structure.

In contrast, in NCM811 for which the surface is fluoridated (also referred to below simply as NCM811-F), which is an example of the positive-electrode active material for a lithium-ion secondary battery of the present embodiment, the presence of fluorine atoms in the lithium metal composite oxide in the fluoride layer stabilizes the intermediate composition between each stable state and the lattice volume is continuously decreased. For this reason, it is presumed that deterioration of the crystal structure is suppressed by reducing lattice strain and the battery characteristics such as the cycle characteristics under high potential conditions are improved as a result.

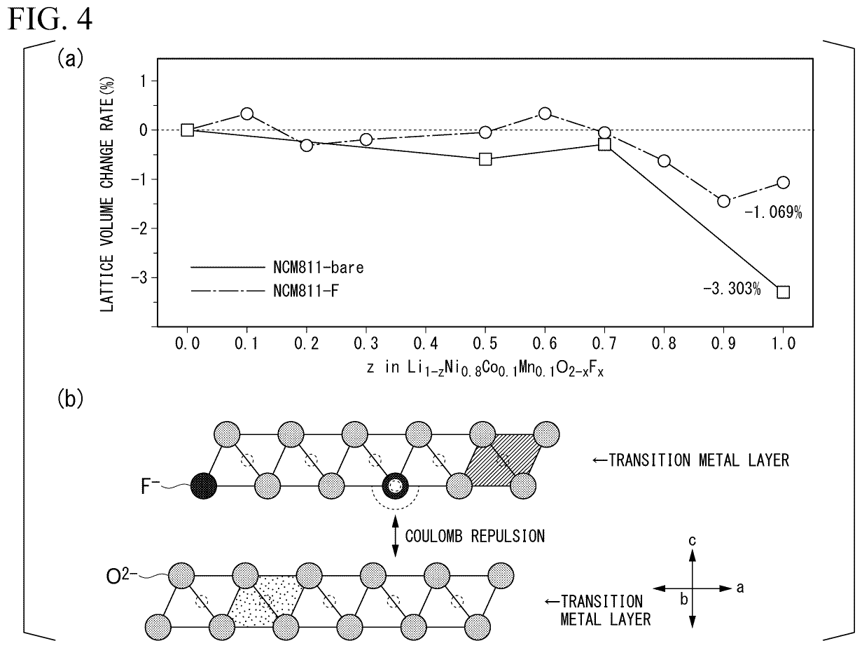

FIG. 4(a) is a graph showing lattice volume change during a lithium-ion desorption reaction process and FIG. 4(b) is a schematic diagram for showing the mechanism of suppressing the lattice volume change in the fluoride of the lithium metal composite oxide.

As shown in FIG. 4(a), in NCM811-bare having the configuration of the related art, the lattice volume change rate during the desorption reaction process during discharging is large, in particular, in the range of z≤0.7, as the number of lithium elements in the lithium metal composite oxide decreases, the lattice volume change rate increases, exhibiting a maximum value of −3.303% (z=1.0).

In contrast, in the NCM811-F of the present embodiment, the lattice volume change rate during the desorption reaction process during discharging is small and exhibits a maximum value of −1.069% (z=1.0) in the range of z≤0.7 and the maximum value of the lattice volume change rate is significantly smaller than that of the configuration of the related art. Considering the reason for the above, for example, as shown in FIG. 4(b), by introducing a fluoride element into the lithium metal composite oxide, the fluoride element is coordinated between adjacent transition metal layers of the layered rock salt-type structure. For this reason, it is considered that the Coulomb's force generated between the fluorine atoms in one transition metal layer and the oxygen atoms in the other transition metal layer in relation to the c-axis direction of the transition metal layer increases more than the Coulomb's force generated between oxygen atoms and a decrease in the distance between the transition metal layers is suppressed and, as a result, the lattice volume change rate is suppressed and the battery characteristics under high potential conditions are improved.

### [Configuration of Positive Electrode for Lithium-Ion Secondary Battery]

The positive electrode for a lithium-ion secondary battery according to the present embodiment has a positive electrode current collector and an electrode active material-containing layer provided on the positive electrode current collector.

### <Positive Electrode Current Collector>

The positive electrode current collector is formed of, for example, a metal foil. Metal foils are suitable for use in a variety of battery shapes, such as cylindrical, prismatic, and laminated types. In order to further improve the adhesion between the positive-electrode active material and the positive electrode current collector, carbon may be vapor-deposited on the surface of the positive electrode current collector.

For example, it is possible to use an aluminum foil as the positive electrode current collector. The positive electrode current collector is preferably made to be hydrophilic by a surface treatment. By making the surface of the positive electrode current collector hydrophilic, hydrogen bonds are easily formed when the positive electrode forming slurry is dried and it is possible to obtain an electrode with high adhesive strength. Examples of the hydrophilization treatment on the surface of the positive electrode current collector include a method (UV/O₃ treatment) for irradiating ultraviolet rays (UV) in an ozone (O₃) atmosphere, or the like.

### <Positive-Electrode Active Material-Containing Layer>

The positive-electrode active material-containing layer includes the positive-electrode active material for a lithium-ion secondary battery according to the present embodiment. By using a lithium salt of the above-described ternary transition metal oxide having a layered rock salt-type structure as the positive-electrode active material, it is possible to obtain a lithium-ion secondary battery having excellent energy density and thermal stability.

In addition, lithium salt particles of a ternary transition metal oxide such as NCM have a smaller particle size and a larger specific surface area (approximately 10 times) than particles of LCO or the like. Due to this, it is possible to increase the contact area between the active material particles and the electrolyte. As a result, the action and effect of suppressing the reaction between the electrode active material and the electrolyte by the fluoride layer becomes remarkable and, compared to a case where the present configuration is not adopted, it is possible to improve the conductivity of the lithium-ions between the active material particles and the electrolyte and to increase the power of the lithium-ion secondary battery.

In addition, by using a lithium salt of the above-described ternary transition metal oxide having a layered rock salt-type structure as the positive-electrode active material, the positive-electrode active material includes Ni as a constituent element. In such a case, the capacity density of the lithium-ion secondary battery tends to increase and the elution of metal elements in the charged state tends to decrease. In particular, in a case where a high nickel-based lithium metal composite oxide represented by LiNiₖCoₗMnₘO₂ (k+l+m=1, k≥0.6) is used as the positive-electrode active material, the above-described effect becomes remarkable. Due to this, compared to a case where the present configuration is not adopted, it is possible to improve the long-term reliability of the lithium-ion secondary battery in a charged state and to improve the cycle characteristics of the lithium-ion secondary battery.

The positive-electrode active material may have first positive-electrode active material particles and second positive-electrode active material particles having a larger particle size than the first positive-electrode active material particles. The first positive-electrode active material particles are, for example, primary particles. The second positive-electrode active material particles may be primary particles or secondary particles. Due to this, the first positive-electrode active material particles having a small particle size enter the gaps between the second positive-electrode active material particles having a large particle size and increase the density, making it possible to increase the energy density by increasing the electrode density. In addition, using first positive-electrode active material particles having a smaller particle size than the second positive-electrode active material particles makes it possible to mitigate destruction of the positive-electrode active material due to volume expansion and contraction.

The particle size of the first positive-electrode active material particles is preferably 0.1 μm or more and 4 μm or less and more preferably 0.7 μm or more and 2 μm or less. The particle size of the second positive-electrode active material particles is preferably 5 μm or more and 20 μm or less and more preferably 6 μm or more and 15 μm or less.

The material forming the first positive-electrode active material particles may be the same as or different from the material forming the second positive-electrode active material particles. In addition, the shape of the first positive-electrode active material particles may be the same as or different from the shape of the second positive-electrode active material particles.

### [Method for Manufacturing Positive-Electrode Active Material for Lithium-Ion Secondary Battery]

The method for manufacturing a positive-electrode active material for a lithium-ion secondary battery according to the present embodiment includes a step of placing a rare gas fluoride and a lithium metal composite oxide in a sealed space and forming a fluoride layer formed of a fluoride of the lithium metal composite oxide on the lithium metal composite oxide.

Specifically, for example, a rare gas fluoride (solid) and a lithium metal composite oxide are stored in a sealed container and left to stand for a predetermined period of time at room temperature or with heating as necessary. As the rare gas fluoride, for example, it is possible to use xenon fluoride. At this time, the XeF₂ (solid) left to stand in the container is vaporized to generate XeF₂ (gas), the XeF₂ (gas) is further decomposed to generate fluoride ions (F⁻), and oxygen atoms on or near the surface of the lithium metal composite oxide are replaced with fluorine atoms. Due to this, it is possible to easily form a fluoride layer on or near the surface of the lithium metal composite oxide.

In the step of forming the fluoride layer, the time for leaving the rare gas fluoride and the lithium metal composite oxide in a sealed space is preferably 12 minutes to 180 minutes, more preferably 15 minutes to 90 minutes, and even more preferably 20 minutes to 30 minutes.

The xenon fluoride is preferably formed of xenon difluoride (XeF₂) from the viewpoint of ease of evaporation; however, without being limited thereto, other than xenon difluoride (XeF₂), xenon (XeF₄) tetrafluoride and/or xenon hexafluoride (XeF₆) may also be included. In addition, from the viewpoint of generating more fluoride ions, the inside of the container may be heated at a predetermined temperature when the rare gas fluoride and the lithium metal composite oxide are left to stand in the container.

The method for manufacturing a positive-electrode active material for a lithium-ion secondary battery may further include a step of heat treating the lithium metal composite oxide on which the fluoride layer is formed after the step of forming the fluoride layer. Through this heat treatment, the fluoride ions in the fluoride layer are further diffused in the inner part and the oxygen atoms in the inner part of the lithium metal composite oxide are replaced with fluorine atoms. As a result, it is possible to form a thicker fluoride layer on the surface of the lithium metal composite oxide. In addition, through this heat treatment, it is possible to increase the atomic concentration ratio of fluorine atoms to oxygen atoms in the fluoride layer 11b compared to a case where the heat treatment is not performed.

In the step described above, the lithium metal composite oxide on which the fluoride layer is formed is heated, for example, at 300° C. to 1000° C. for 3 hours to 10 hours. As the temperature range, the heat treatment may be performed at 500° C. or lower, 470° C. or lower, or 450° C. or lower. In addition, the lithium metal composite oxide on which the fluoride layer is formed may be heat treated at, for example, 330° C. or higher or 350° C. or higher.

### [Structure of Lithium-Ion Secondary Battery]

The lithium-ion secondary battery according to the present embodiment is provided with the positive electrode for a lithium-ion secondary battery described above, a negative electrode, and an electrolyte. It is possible for this secondary battery to have the same configuration as a secondary battery which is known or of the related art, except for having the electrode described above.

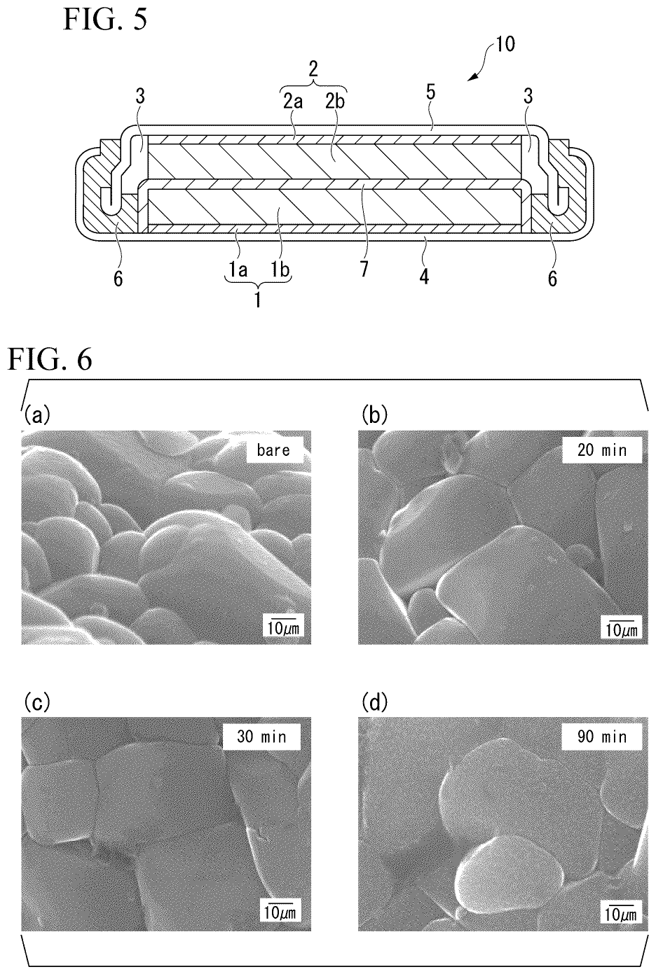

FIG. 5 is a cross-sectional view showing an example of a specific configuration of the lithium-ion secondary battery according to the present embodiment.

As shown in FIG. 5, a lithium-ion secondary battery 10 is a coin-type secondary battery and is provided with a positive electrode 1, a negative electrode 2, and an electrolyte 3. The positive electrode 1 is provided with a positive electrode current collector 1a and a positive-electrode active material-containing layer 1b provided on the positive electrode current collector 1a. The negative electrode 2 is provided with a negative electrode current collector 2a and a negative electrode active material-containing layer 2b provided on the negative electrode current collector 2a. The electrolyte 3 is, for example, an electrolytic solution.

In addition, it is possible for the lithium-ion secondary battery 10 to be provided with a separator 7 provided between the positive electrode 1 and the negative electrode 2, a positive electrode side case 4 and a negative electrode side case 5 made of stainless steel that work together to store the positive electrode 1, the negative electrode 2, and the electrolyte 3 therein, and a gasket 6 made of polypropylene interposed between the positive electrode side case 4 and the negative electrode side case 5 at the outer peripheries thereof.

### (Positive Electrode)

The positive electrode 1 is not particularly limited except for having the positive electrode current collector 1a and the positive-electrode active material-containing layer 1b as described above. It is possible to manufacture the positive electrode 1, for example, by preparing a positive electrode mixture including the lithium metal composite oxide, a conductive material, and a binder.

### (Conductive Material)

It is possible to use a carbon material as the conductive material of the positive electrode. Examples of carbon materials include graphite powder, carbon black (for example, acetylene black), fibrous carbon materials, and the like. Since carbon black is made of fine particles and has a large surface area, adding a small amount thereof to the positive electrode mixture makes it possible to increase the conductivity of the inner part of the positive electrode and to improve the charge/discharge efficiency and output characteristics, but when an excessive amount thereof is added, the binding force between the positive electrode mixture and the positive electrode current collector due to the binder and the binding force inside the positive electrode mixture are both decreased, which, in contrast, is a factor causing an increase in the resistance of the inner part.

### (Binder)

It is possible to use a thermoplastic resin as the binder of the positive electrode. Examples of this thermoplastic resin include fluororesins such as polyvinylidene fluoride (also referred to below as PVdF), polytetrafluoroethylene (also referred to below as PTFE), a tetrafluoroethylene/propylene hexafluoride/vinylidene fluoride-based copolymer, a propylene hexafluoride/vinylidene fluoride-based copolymer, and a tetrafluoroethylene/perfluorovinylether-based copolymer; and polyolefin resins such as polyethylene and polypropylene.

In a case of making a paste of the positive electrode mixture, usable organic solvents include amine-based solvents such as N,N-dimethylaminopropylamine and diethylenetriamine; ether-based solvents such as tetrahydrofuran; ketone-based solvents such as methyl ethyl ketone; ester-based solvents such as methyl acetate; and amide-based solvents such as dimethylacetamide and N-methyl-2-pyrrolidone (may be referred to below as NMP).

### (Negative Electrode)

The negative electrode active material-containing layer 2b of the negative electrode 2 includes at least a negative electrode active material. As the negative electrode active material, it is possible to use compounds capable of absorbing and emitting lithium-ions alone or in combination. Examples of compounds capable of absorbing and emitting lithium-ions include metal materials such as lithium, alloy materials containing titanium, silicon, tin, and the like, and carbon materials such as graphite, coke, organic polymer compound sintered bodies, and amorphous carbon.

It is possible to use these negative electrode active materials not only alone, but also in a mixture of a plurality of types. Among these substances, as negative electrode active materials, titanium-containing oxides (for example, bronze-structured titanium oxide TiO₂ (B), lithium titanate Li₄Ti₅O₂), silicon oxide, natural graphite, artificial graphite, hard carbon, soft carbon, silicon, alloys including silicon (for example, Si₈₀Ti₂₀), tin, or the like are preferably used.

For example, in a case of using a lithium foil as the negative electrode active material, it is possible to form the negative electrode active material by pressing the lithium foil onto the surface of a negative electrode current collector formed of a metal such as copper.

In addition, in a case of using an alloy material or a carbon material as the negative electrode active material, it is possible to form the negative electrode active material by mixing the negative electrode active material, a binding material, a conductive agent, and the like in a solvent such as water or N-methylpyrrolidone and then coating the result on a negative electrode current collector formed of a metal such as copper. The binding material is desirably formed of a polymer material and is desirably a material that is chemically and physically stable in the atmosphere inside the lithium secondary battery.

Examples of the binding material include polyvinylidene fluoride (PVdF), polytetrafluoroethylene (PTFE), ethylene-propylene-diene copolymer (EPDM), styrene-butadiene rubber (SBR), acrylonitrile-butadiene rubber (NBR), fluororubber, and the like.

Examples of the conductive agent include Ketjen black, acetylene black, carbon black, graphite, carbon nanotubes, amorphous carbon, and the like. In addition, it is possible to exemplify conductive polymer polyaniline, polypyrrole, polythiophene, polyacetylene, and polyacene.

### (Electrolytic Solution)

The electrolytic solution is a medium that transports charged carriers such as ions between the positive electrode and the negative electrode and is not particularly limited; however, an electrolytic solution which is physically, chemically, and electrically stable in the atmosphere in which the lithium-ion secondary battery is used is desirable.

For example, as an electrolytic solution, an electrolytic solution in which one or more selected from LiBF₄, LiPF₆, LiCF₃SO₃, LiN(CF₃SO₂)₂, LiN(C₂F₅SO₂)₂, and LiN(CF₃SO₂)(C₄F₉SO₂) is set as a supporting electrolyte and dissolved in an organic solvent is preferable.

As organic solvents, it is possible to exemplify propylene carbonate, ethylene carbonate, 1,2-dimethoxyethane, dimethyl carbonate, diethyl carbonate, ethylmethyl carbonate, tetrahydrofuran, 2-methyltetrahydrofuran, tetrahydropyran, and the like as well as mixtures thereof. Among the above, an electrolytic solution including a carbonate-based solvent is preferable due to having high stability at high temperatures. In addition, it is also possible to use a solid polymer electrolyte including the above-described electrolyte in a solid polymer such as polyethylene oxide, or a solid electrolyte such as ceramic or glass having lithium-ion conductivity.

It is desirable to interpose a separator, which is a member that has both an electrical insulation action and an ion conduction action, between the positive electrode and the negative electrode. In a case where the electrolyte is liquid, the separator also plays the role of holding the liquid electrolyte. As the separator, it is possible to exemplify porous synthetic resin membranes, in particular, porous membranes formed of polyolefin polymers (polyethylene, polypropylene) or glass fibers, and non-woven fabrics. Furthermore, it is preferable to adopt a separator having a shape even larger than the positive electrode and negative electrode in order to ensure insulation between the positive electrode and negative electrode.

The positive electrode, negative electrode, electrolyte, separator, and the like are generally stored in a case formed of the positive electrode side case 4, the negative electrode side case 5, and the like as described above. It is possible to create a case using known materials and shapes without being particularly limited. That is, the lithium secondary battery of the present invention is not particularly limited in the shape thereof and is usable as batteries having various shapes such as a coin shape, a cylindrical shape, and a square shape. In addition, the case of the lithium secondary battery of the present embodiment is not limited and is usable as a battery in various forms, such as a case formed of metal or of resin, which is able to maintain an external shape, or a case of a soft material such as a laminate pack.

### EXAMPLES

A description will be given below of Examples of the present invention. The present invention is not limited only to the following Examples.

### Example 1

### <Manufacturing of Positive Electrode for Lithium-Ion Secondary Battery>

100 parts by mass of NCM811 (manufactured by Hohsen Corp., Ni: 80% by mass, Co: 10% by mass, Mn: 10% by mass) and 12 parts by mass of XeF₂ (manufactured by Wako Pure Chemical Industries, Ltd.) were sealed in a PTFE container in a glove box and left to stand at room temperature for 20 minutes. The molar ratio of NCM811 and XeF₂ during charging was 14.5:1. After 20 minutes elapsed, the result was taken out from the container to obtain a positive-electrode active material (NCM811-F_20 min) formed of fluoride of a lithium metal composite oxide.

A positive-electrode active material (NCM811-F_20 min) and Denka Black (registered trademark) (manufactured by Denka Co., Ltd., a conductive agent) were weighed and mixed in a mortar and then placed in a special container and kneaded for 2 minutes using a mixer (manufactured by Thinky Corp., product name: the “Awatori Rentaro”). After confirming that the mixture was sufficiently stirred, a binder (PVdF/NMP: 10% by mass) was weighed and added dropwise thereto, followed by kneading for 2 minutes using a mixer. Next, 40 L of NMP was added dropwise thereto, kneaded for 3 minutes using a mixer, defoamed for 30 seconds, then, 50 L of NMP was further added dropwise thereto, kneaded for 5 minutes using a mixer, and defoamed for 30 seconds.

The obtained slurry was coated on aluminum foil and dried under atmospheric pressure at 100° C. Next, the result was punched out using a punching machine and vacuum dried at 120° C. for 24 hours. After the vacuum drying finished, press molding was carried out using a roll press to obtain a positive electrode. At this time, the mass ratio of the positive-electrode active material:conductive agent:binder in the positive electrode was 90:5:5.

### <Preparation of Coin Half-Cell>

A positive electrode can (positive electrode side case), the positive electrode for a lithium-ion secondary battery obtained above, a separator (Celgard (registered trademark), #2400), a gasket, a negative electrode (lithium metal), a spacer, a spring, and a negative electrode can (negative electrode side case) were laminated in this order, 140 L of an electrolytic solution (1M LiPF₆ EC/DMC (1:2)) was placed in the inner part of the positive electrode can, and 70 L of the same electrolytic solution was stored in the inner part of the negative electrode can to prepare a coin half-cell. A lithium foil was used for the negative electrode.

### Example 2

A positive-electrode active material (NCM811-F_30 min) was manufactured and a coin half-cell was prepared in the same manner as in Example 1, except that the standing time of NCM811 and XeF₂ in the PTFE container was changed from 20 minutes to 30 minutes.

### Example 3

A positive-electrode active material (NCM811-F_90 min) was manufactured and a coin half-cell was prepared in the same manner as in Example 1, except that the standing time of NCM811 and XeF₂ in the PTFE container was changed from 20 minutes to 90 minutes.

### Comparative Example 1

A coin half-cell was prepared using a positive-electrode active material (NCM811-bare) in the same manner as in Example 1, except that a fluoride layer was not formed on the surface of NCM811 (manufactured by Hohsen Corp., Ni: 80% by mass, Co: 10% by mass, Mn: 10% by mass).

The obtained Examples 1 to 3 and Comparative Example 1 were measured and evaluated by the following methods.

### [External Appearance of Positive-Electrode Active Material]

The positive-electrode active material was observed using a field emission scanning electron microscope (FE-SEM). As a result, in Examples 1 to 2 (FIG. 6(b) to FIG. 6(c)), no change was seen in the external appearance of the surface of the positive-electrode active material, which was the same external appearance as in Comparative Example 1 (FIG. 6(a)). In Example 3 (FIG. 6(c)), fine particle deposits were confirmed to be deposited on the surface of the positive-electrode active material.

### [XRD Measurement]

The positive-electrode active material (NCM811-F) used in Examples 1 to 3 and the positive-electrode active material (NCM811-bare) used in Comparative Example 1 were identified using an XRD apparatus (manufactured by Rigaku Corp., “Smart Lab (registered trademark)” using the powder X-ray diffraction (XRD) method.

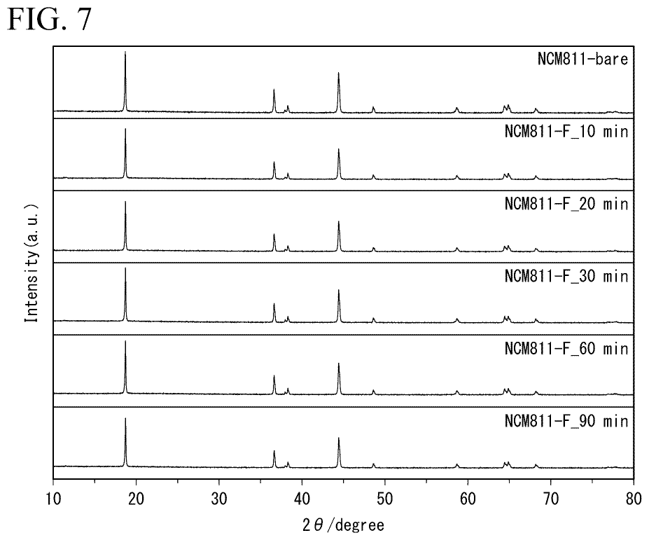

As a result, as shown in FIG. 7, no changes were seen in the spectral peaks of Examples 1 to 3 doped with fluorine atoms compared to Comparative Example 1, which was not doped with fluorine atoms, and it was confirmed that the laminated structure of the raw material NCM811 was almost completely maintained in the positive-electrode active material of Examples 1 to 3.

### [XPS Analysis (1)]

XPS analysis of the surface of the positive-electrode active material was performed under the following conditions and narrow scan spectra of each element on the surface of the positive-electrode active material were obtained.
Measurement method: X-ray photoelectron spectroscopy (XPS)
X-ray source: MgKα ray (1486.6 eV)
X-ray spot diameter: 400 μm
Neutralization conditions: Neutralization electron gun (acceleration voltage 0.2 V, current 100 μA)

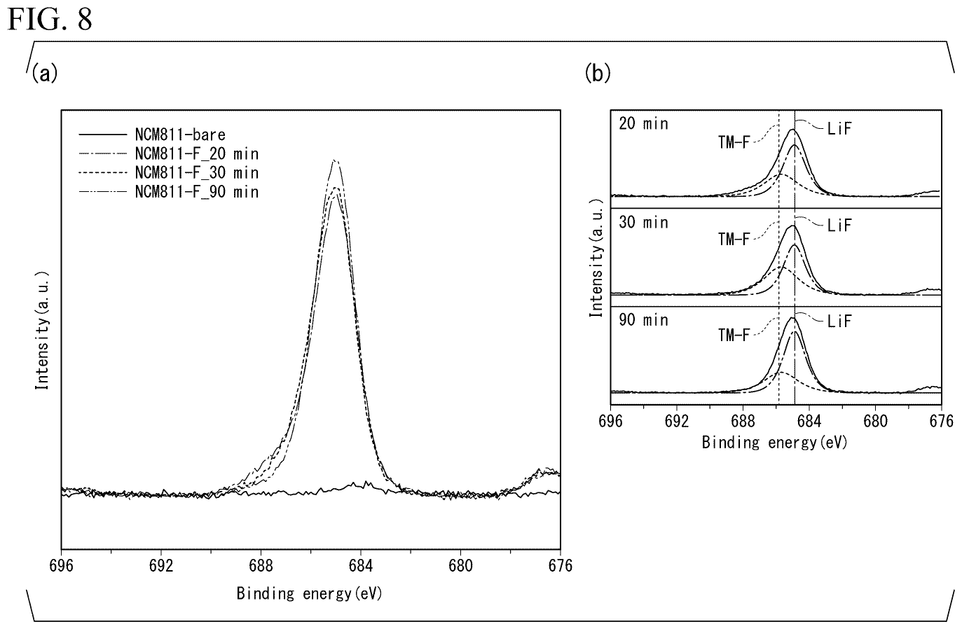

First, XPS spectra of fluorine atoms (1s) in the positive-electrode active materials in Examples 1 to 3 and Comparative Example 1 are shown in FIG. 8(a) and FIG. 8(b). As a result, in Examples 1 to 3, a peak (685.7 eV) attributed to the transition metal-fluorine bond and a peak (684.9 eV) attributed to lithium fluoride (LiF) were detected.

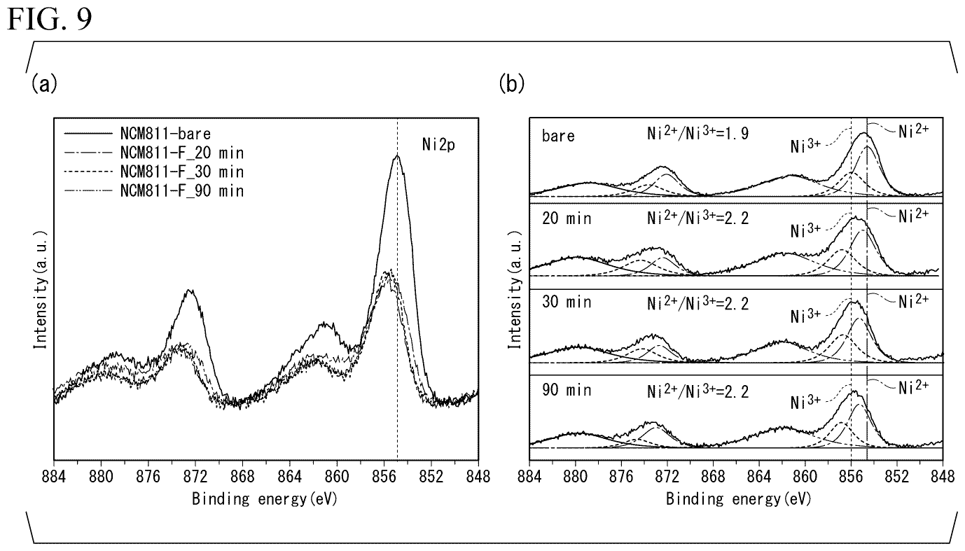

Next, the XPS spectra of the nickel element (2p) in the positive-electrode active materials in Examples 1 to 3 and Comparative Example 1 are shown in FIG. 9(a) and FIG. 9(b). As a result, in Examples 1 to 3, it was confirmed that the peak attributed to nickel was shifted to the high energy side due to the nickel-fluorine bond. In addition, in Examples 1 to 3, it was confirmed that the Ni²⁺/Ni³⁺ ratio was increased compared to Comparative Example 1 due to the charge compensation of the replacement with fluorine atoms.

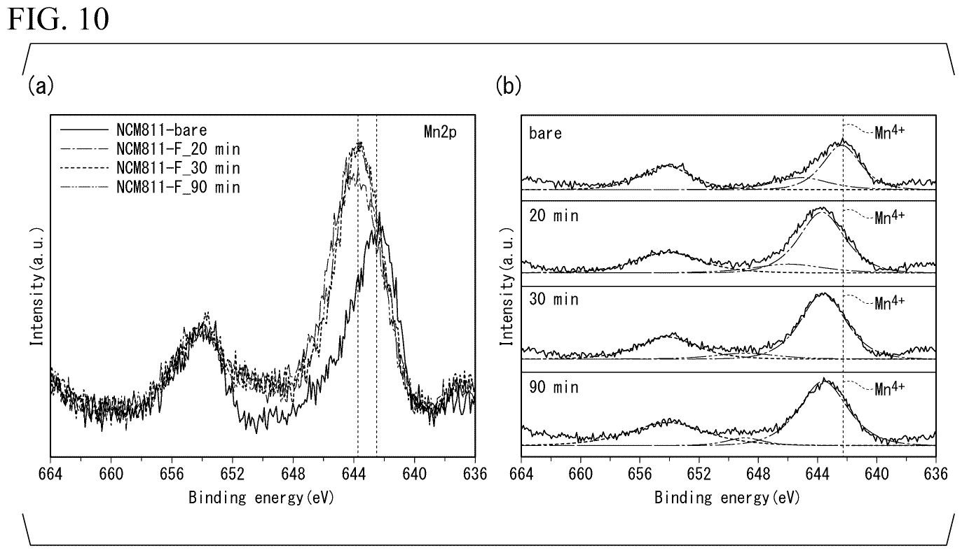

In addition, XPS spectra of the manganese element (2p) in the positive-electrode active materials in Examples 1 to 3 and Comparative Example 1 are shown in FIG. 10(a) and FIG. 10(b). As a result, in Examples 1 to 3, it was confirmed that the peak attributed to manganese was shifted to the high energy side due to the manganese-fluorine bond, in the same manner as for nickel. In addition, in Examples 1 to 3, since there was no change in the valence (4+) of manganese, it was confirmed that the valence of nickel had changed.

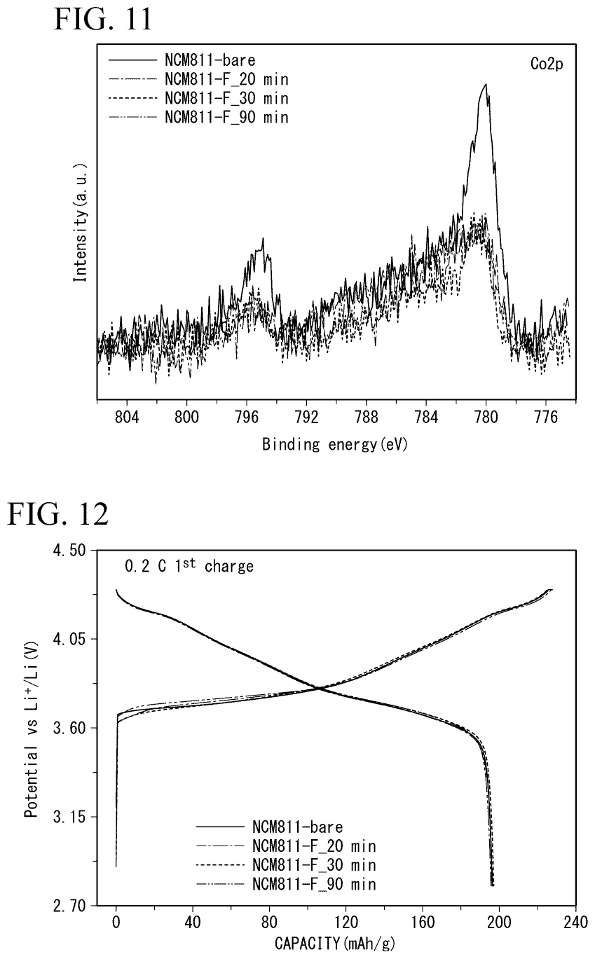

Furthermore, FIG. 11 shows the XPS spectra of the cobalt element (2p) in the positive-electrode active materials in Examples 1 to 3 and Comparative Example 1. As a result, in Examples 1 to 3, it was confirmed that the peak attributed to cobalt did not shift and that there was no change in the valence of cobalt.

### [Cycle Characteristic Evaluation]

The coin half-cells prepared in Examples 1 to 3 and Comparative Example 1 were set in a charging and discharging device (manufactured by Hokuto Denko Co., Ltd., product name “HJ1001SD8”), Li was inserted into and desorbed from the positive electrode in one cycle by charging and discharging, and the cycle characteristics of the positive electrode in one cycle were evaluated. One cycle of charging and discharging was performed at a current density of 0.2 C. The charge/discharge capacity and coulombic efficiency of this charging and discharging were measured. The results are shown in Table 1 and FIG. 12.

TABLE 1

| | Charge | Discharge | Coulombic |
|---|---|---|---|
| | capacity | capacity | efficiency |
| | (mAh/g) | (mAh/g) | (%) |
| Example 1 | 228.0 | 197.6 | 87 |
| Example 2 | 227.0 | 197.9 | 87 |
| Example 3 | 226.9 | 197.4 | 87 |
| Comparative | 228.8 | 196.5 | 86 |
| Example 1 | | | |

From the results in Table 1 and FIG. 12, the initial charge/discharge curves of Examples 1 to 3 were similar to the initial charge/discharge curve of Comparative Example 1 and the charge capacity, discharge capacity, and coulombic efficiency were the same as in Comparative Example 1. Therefore, it was understood that, under the above charge/discharge conditions, the charge/discharge characteristics in one cycle of Examples 1 to 3 were equivalent to the charge/discharge characteristics of Comparative Example 1.

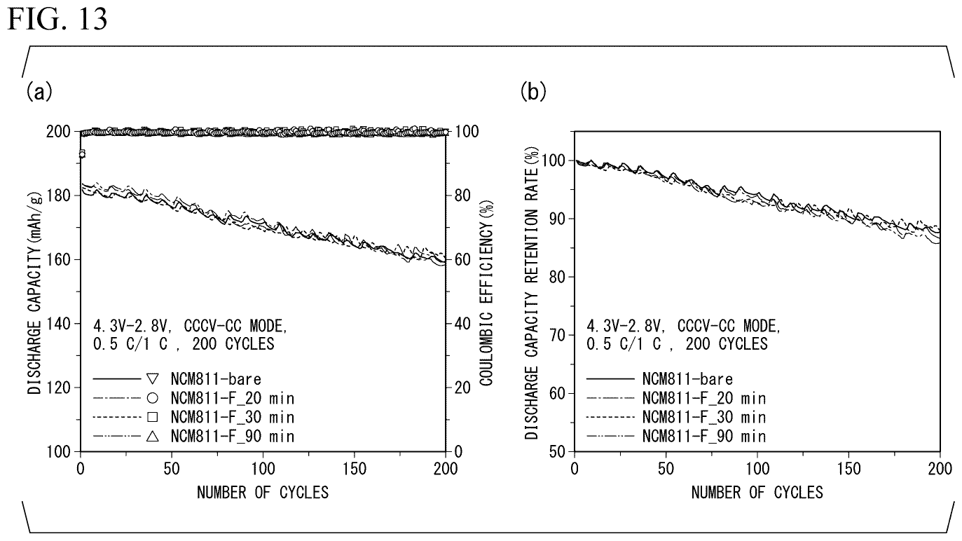

In addition, the cycle characteristics of the coin half-cell at 200 cycles were evaluated. 200 cycles of charging and discharging were performed at a cutoff voltage of 4.3 V to 2.8 V, CCCV-CC mode, and 0.5 C/1 C. The discharge capacity and capacity retention rate of this charging and discharging were measured. The results are shown in FIG. 13(a) and FIG. 13(b). As a result, the discharge capacities of Examples 1 to 3 decreased as the number of cycles increased and transitioned in the same manner as in Comparative Example 1. In addition, the discharge capacity retention rates of Examples 1 to 3 also decreased as the number of cycles increased and transitioned in the same manner as in Comparative Example 1.

Therefore, it was understood that, under the above charge/discharge conditions, the cycle characteristics of Examples 1 to 3 at 200 cycles were also equivalent to the cycle characteristics of Comparative Example 1.

### [Impedance Analysis]

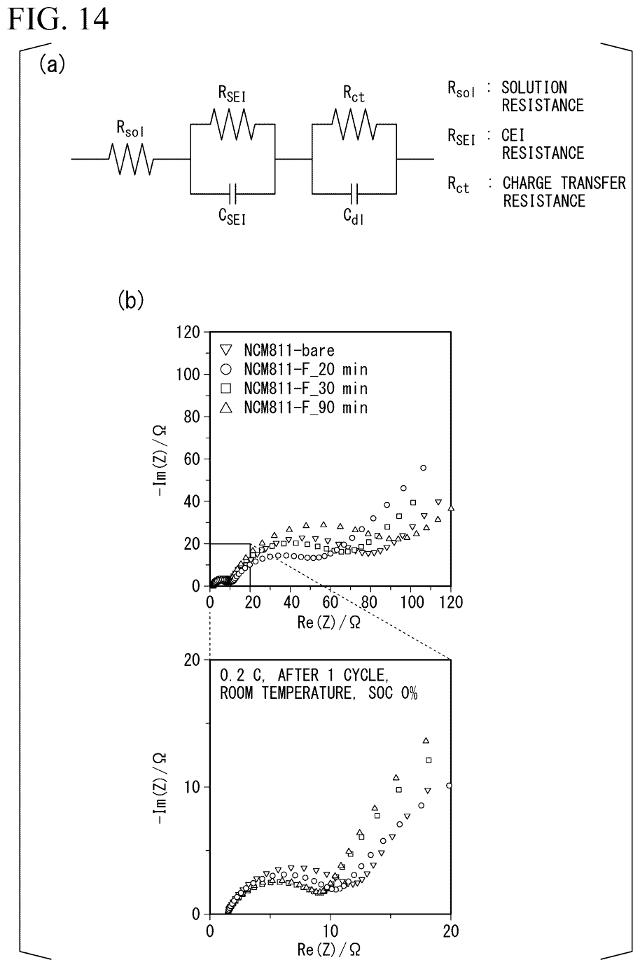

The insertion and desorption of Li into and from the positive electrode by charging and discharging was performed in one cycle and the impedance of the coin half-cell was measured after one cycle. As shown in FIG. 14(a), setting the electrolytic solution resistance as Rₛₒₗ, the resistance of the CEI layer (coating layer) as R_{CEI}, and the charge transfer resistance between the CEI layer and the core particles as R_{ct}, each value was determined. The results are shown in Table 2 and FIG. 14(b). As a result, it was understood that the CEI layer resistance R_{CEI} of Examples 1 to 3 was smaller than the CEI layer resistance R_{CEI} of Comparative Example 1. In addition, it was also understood that the charge transfer resistances R_{ct} of Examples 1 and 2 were smaller than the charge transfer resistance R_{ct} of Comparative Example 1.

TABLE 2

| | Rₛₒₗ | R_{CEI} | R_{ct} |
|---|---|---|---|
| | (Ω) | (Ω) | (Ω) |
| Example 1 | 1.4 | 9.1 | 43.4 |
| Example 2 | 1.4 | 8.1 | 56.2 |
| Example 3 | 1.4 | 8.0 | 81.1 |
| Comparative | 1.4 | 10.7 | 65.2 |
| Example 1 | | | |

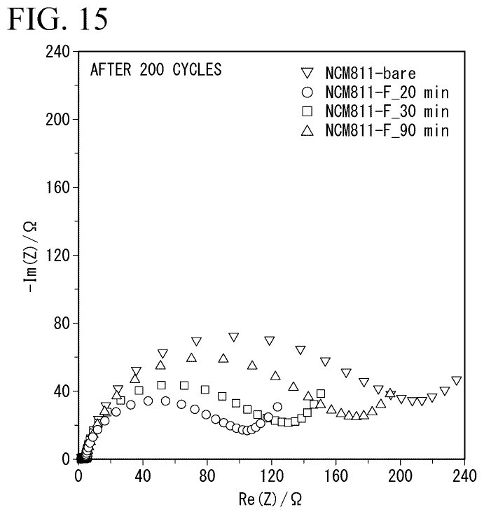

Next, the total cell resistance was set as Rₜₒₗ(=Rₛₒₗ+R_{CEI}+R_{ct}) and the impedance of the coin half-cell was measured after 1 cycle and after 200 cycles. The results are shown in Table 3, FIG. 15(a), and FIG. 15(b). As a result, the total cell resistance Rₜₒₗ after one cycle in Examples 1 to 3 was smaller than the total cell resistance Rₜₒₗ in Comparative Example 1 and the total cell resistance Rioᵢ after 200 cycles was also smaller than the total cell resistance Rₜₒₗ in Comparative Example 1. In addition, the resistance difference in the total cell resistance Rₜₒₗ after 1 cycle and after 200 cycles was significantly larger than the resistance difference in Comparative Example 1 and it was understood that the formation of the oxyfluoride layer suppressed the increase in the total cell resistance after the cycles.

In addition, the total cell resistance Rₜₒₗ in one cycle of Examples 1 and 2 was smaller than the total cell resistance Rₜₒₗ of Example 3 and the total cell resistance Rₜₒₗ after 200 cycles was also smaller than the total cell resistance Rₜₒₗ of Example 3. From the above, in Examples 1 and 2, a thinner CEI layer was formed compared to Example 3 and it is presumed that, while the decomposition of the electrolytic solution, such as LiPF₆ and EC, and the elution of nickel or the like are suppressed, the lithium-ion conduction is better.

TABLE 3

| | Rₜₒₗ | Rₜₒₗ | |
|---|---|---|---|
| | (after | (after | Resistance |
| | 1 cycle) | 200 cycles) | difference |
| | (Ω) | (Ω) | (Ω) |
| Example 1 | 53.9 | 94.9 | 41.4 |
| Example 2 | 65.7 | 113.1 | 47.4 |
| Example 3 | 90.5 | 152.5 | 62.0 |
| Comparative | 77.3 | 184.5 | 107.2 |
| Example 1 | | | |

### [Output Characteristics Evaluation]

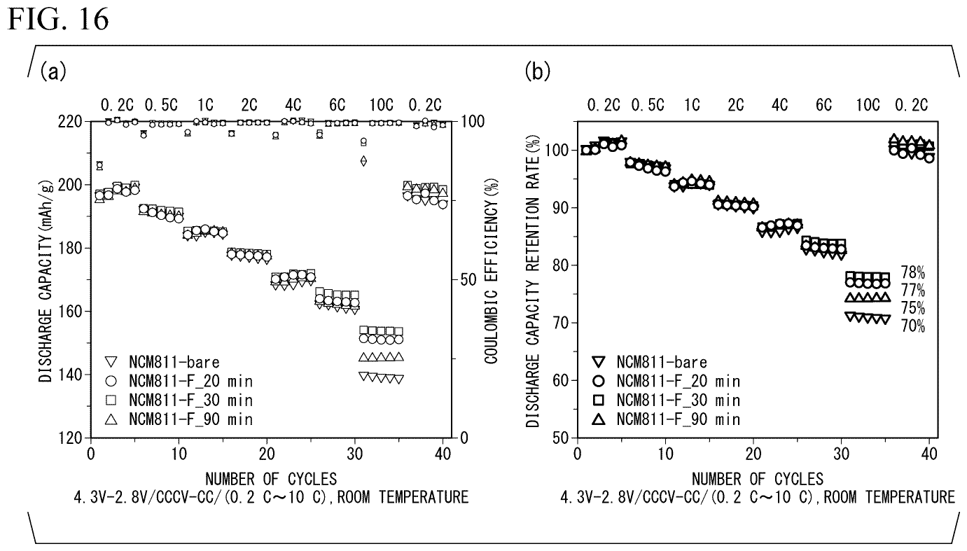

The insertion and desorption of Li into and from the positive electrode by charging and discharging was performed for 40 cycles and the output characteristics of the coin half-cell were evaluated. 40 cycles of charging and discharging were performed at a cutoff voltage of 4.3 V to 2.8 V, CCCV-CC mode, 0.2 C to 10 C, and room temperature. The results are shown in FIG. 16(a) and FIG. 16(b). As a result, the discharge capacities of Examples 1 to 3 were greater than in Comparative Example 1 at 20 cycles or more and the discharge capacity retention rates of Examples 1 to 3 were also greater than in Comparative Example 1 at 20 cycles or more. Therefore, it was understood that the output characteristics of Examples 1 to 3 after 40 cycles were superior to Comparative Example 1 due to the formation of the oxyfluoride layer.

### [UPS Measurement]

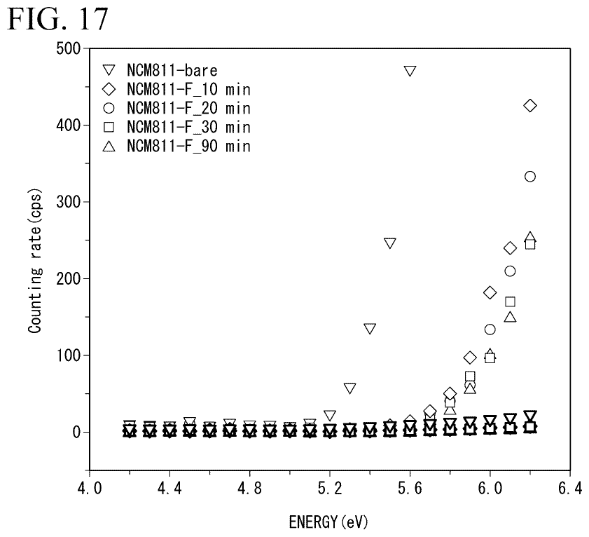

UPS measurement of the surface of the positive-electrode active material was performed under the following conditions and the work function of the positive-electrode active material was evaluated. The work function was calculated from the following formula. The results are shown in FIG. 17 and Table 4.
Measurement method: Ultraviolet photoelectron spectroscopy (UPS)
Ultraviolet light source: Deuterium lamp
Measurement light intensity: 50 nW
Setting light intensity: 50 nW
Starting energy: 4.2 eV
Termination energy: 6.2 eV
Step: 0.10 eV

TABLE 4

| | Work function | Δ |
|---|---|---|
| | (eV) | (eV) |
| Example 1 | 5.49 | 0.33 |
| Example 2 | 5.57 | 0.41 |
| Example 3 | 5.58 | 0.42 |
| Comparative | 5.16 | — |
| Example 1 | | |

From the results in FIG. 17 and Table 4, the work functions of Examples 1 to 3 are larger than the work function of Comparative Example 1, and the energy difference A between Examples 1 to 3 and Comparative Example 1 is +0.31 to +0.42 eV. Therefore, it was understood that forming the oxyfluoride layer makes it possible to suppress electron emissions at the surface of the positive-electrode active material more than in Comparative Example 1.

### [Measurement of Composition Ratio in Thickness Direction of Fluoride Layer]

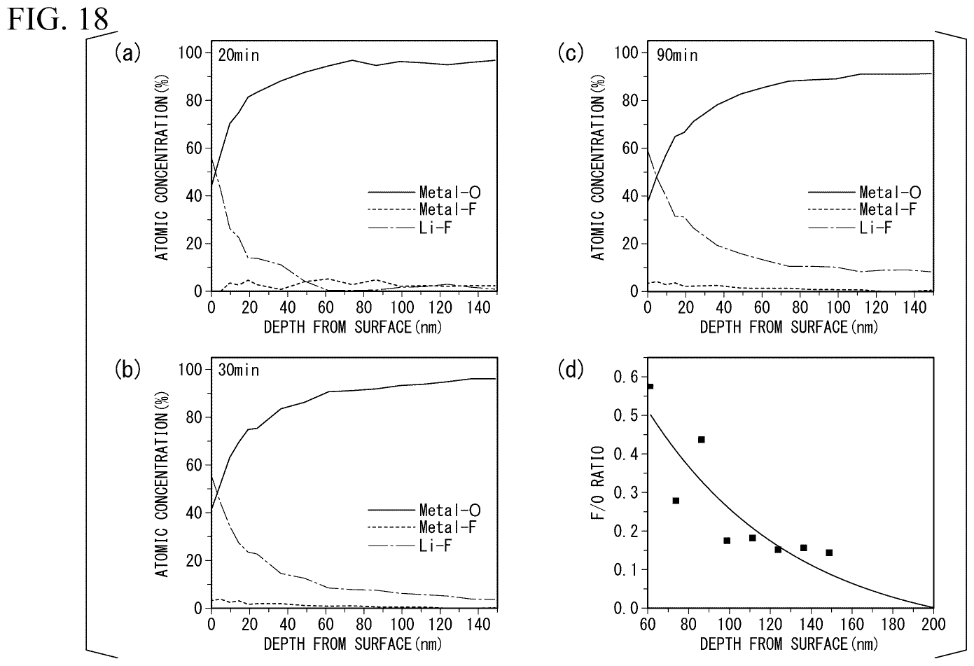

Using the XPS described above, changes in the concentration content of each element in relation to the direction from the outer surface to the inner part of the positive-electrode active materials in Examples 1 to 3 were measured. In each Example, the oxygen atom concentration in the transition metal-oxygen atom bond, the fluorine atom concentration in the transition metal-fluorine bond, and the fluorine atom concentration in lithium fluoride (LiF) were measured. The results are shown in FIG. 18(a) to FIG. 18(c). The “DEPTH FROM SURFACE” on the horizontal axis in FIG. 18(a) to FIG. 18(d) is an SiO₂-converted value. From this result, it was understood that, in all of Examples 1 to 3, the fluorine atom concentration of lithium fluoride (LiF) decreases as the depth from the surface increases. In addition, in Examples 2 and 3, it was understood that the fluorine atoms in the transition metal-fluorine bond decreased slightly as the depth from the surface increased. Furthermore, in Example 1, as shown in FIG. 18(d), it was understood that the concentration ratio of fluorine atoms (F/O ratio) to oxygen atoms in the fluoride layer decreases as the depth from the surface increases.

### [Cyclic Voltammetry Measurement]

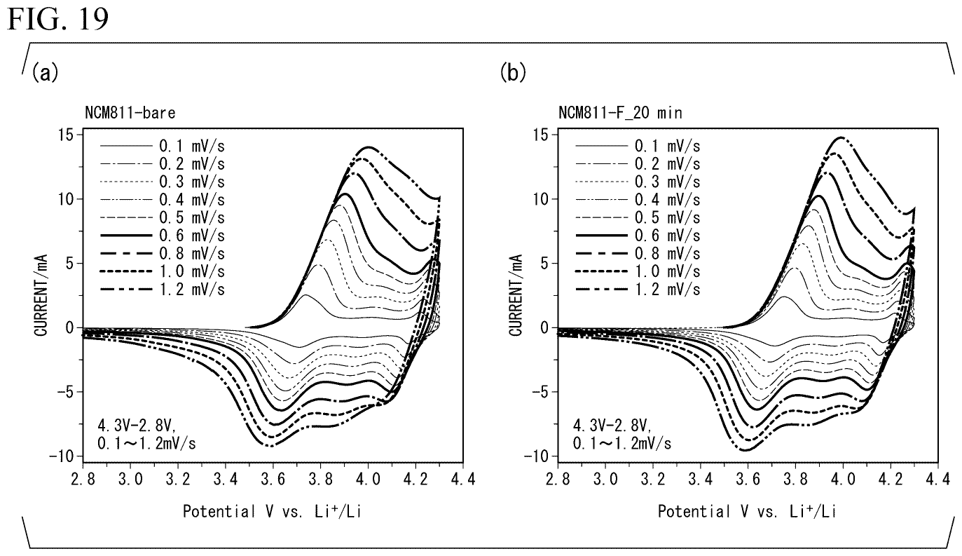

The coin half-cells prepared in Example 1 and Comparative Example 1 were measured using a cyclic voltammetry method (CV method). The results are shown in FIG. 19(a) and FIG. 19(b). In the figures, the horizontal axis shows the voltage (V, vs. Li⁺/Li) applied to the solution and the vertical axis shows the output current density (mA). As a result, in Comparative Example 1, D_{Li_Ox}=5.0×10⁻⁷ cm²·s⁻¹ and D_{Li_Red}=2.3×10⁻⁷ cm²·s⁻¹, whereas in Example 1, D_{Li_Ox}=5.8×10⁻⁷ cm²·s⁻¹ and D_{Li_Red}=2.6×10⁻⁷ cm²·s⁻¹ and it was understood that, in Example 1, the diffusion coefficient of the lithium-ions increased due to the formation of the oxyfluoride layer.

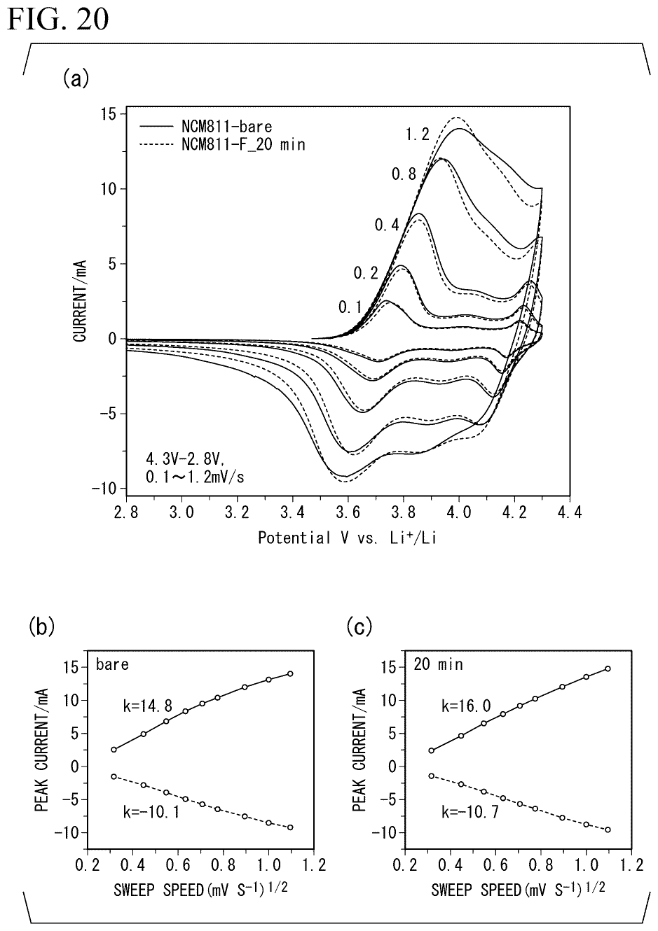

In addition, when comparing the cyclic voltammetry (CV) in Example 1 and Comparative Example 1, Example 1 maintained an oxidation-reduction peak shape even at a high voltage sweep speed. Furthermore, as shown in FIG. 20(b), in Comparative Example 1, the reaction rate constant during charging and discharging is k=14.8, −10.1, whereas in Example 1, the reaction rate constant during charging and discharging is k=16.0, −10.7, and it was understood that the charge transfer by the lithium-ions was faster in Example 1 than in Comparative Example 1.

[Cycle Characteristics Evaluation under High Rate Conditions]

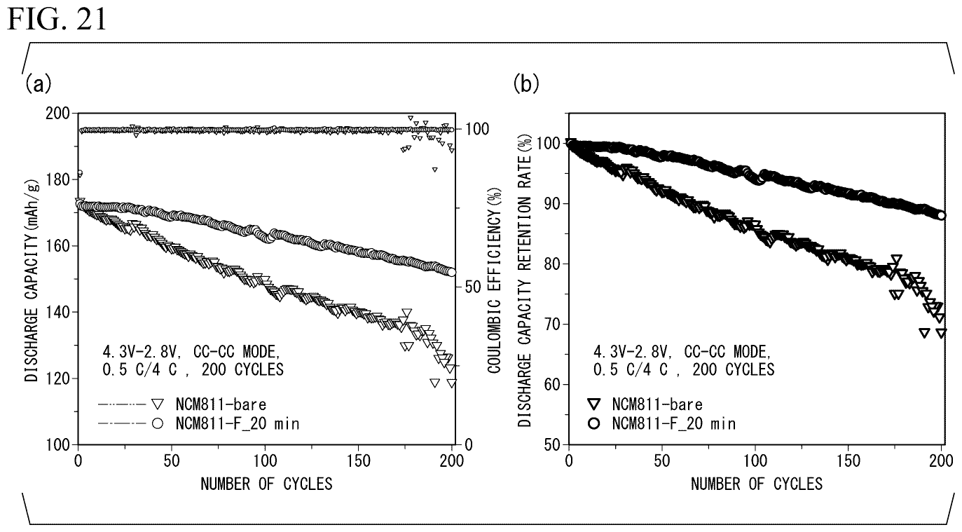

Under high rate conditions, the insertion and desorption of Li into and from the positive electrode by charging and discharging was performed for 200 cycles and the cycle characteristics of the coin half-cell were evaluated at 200 cycles. 200 cycles of charging and discharging were performed at a cutoff voltage of 4.3 V to 2.8 V, CCCV-CC mode, and 0.5 C/4 C. The discharge capacity and capacity retention rate of this charging and discharging were measured. The results are shown in FIG. 21(a) and FIG. 21(b). As a result, it was understood that, in Example 1, the amount of the decrease in the discharge capacity due to the increase in the number of cycles was smaller than in Comparative Example 1 and, in Example 1, the amount of the decrease in the discharge capacity retention rate due to the increase in the number of cycles was smaller than in Comparative Example 1. In particular, the discharge capacity retention rate after 200 cycles in Comparative Example 1 was 68%, whereas the discharge capacity retention rate after 200 cycles in Example 1 was 88%. Therefore, it was understood that, under high rate conditions, the cycle characteristics of Example 1 were significantly superior to Comparative Example 1 due to the formation of the oxyfluoride layer.

### [Cycle Characteristic Evaluation Under High Potential Conditions]

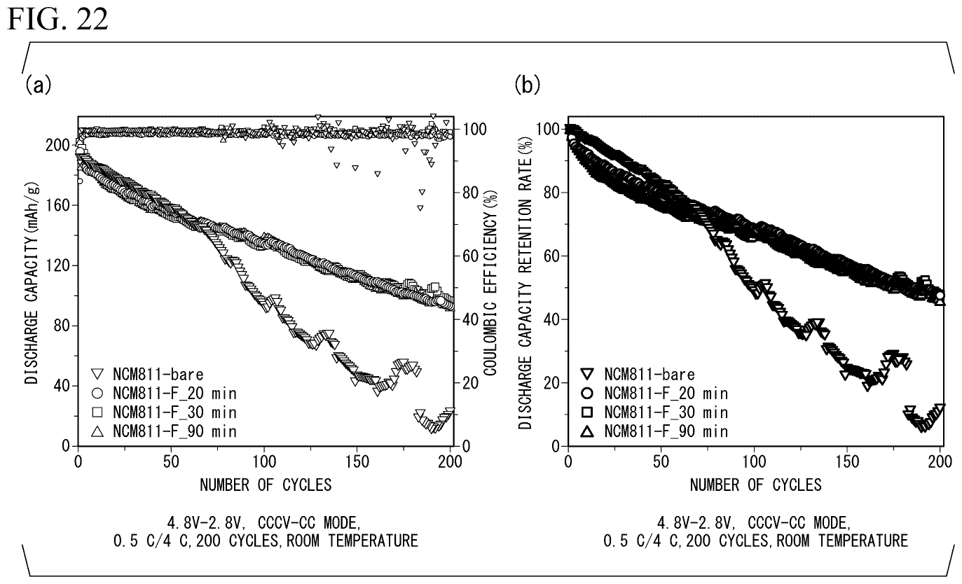

Under high potential conditions, the insertion and desorption of Li into and from the positive electrode by charging and discharging was performed for 200 cycles and the cycle characteristics of the coin half-cell were evaluated. 200 cycles of charging and discharging were performed at a cutoff voltage of 4.8 V to 2.8 V, CCCV-CC mode, 0.5 C to 4 C, and room temperature. The results are shown in FIG. 22(a) and FIG. 22(b). As a result, the discharge capacities of Examples 1 to 3 are greater than in Comparative Example 1 at approximately 70 cycles or more and the discharge capacity retention rates of Examples 1 to 3 are also greater than in Comparative Example 1 at approximately 70 cycles or more. In particular, the discharge capacity retention rate after 200 cycles in Comparative Example 1 was approximately 17%, whereas the discharge capacity retention rate after 200 cycles in Examples 1 to 3 was approximately 50%. Therefore, it was understood that, under high potential conditions, the cycle characteristics of Examples 1 to 3 were significantly superior to Comparative Example 1 due to the formation of the oxyfluoride layer.

### [Evaluation of Output Characteristics Under High Potential Conditions]

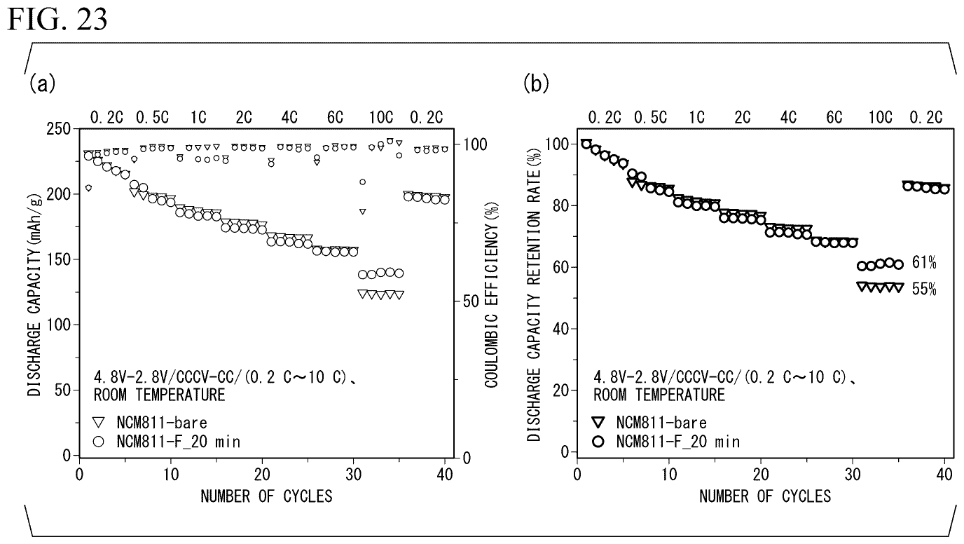

Under high potential conditions, the insertion and desorption of Li into and from the positive electrode by charging and discharging was performed for 40 cycles and the output characteristics of the coin half-cell were evaluated. 40 cycles of charging and discharging were performed at a cutoff voltage of 4.8 V to 2.8 V, CCCV-CC mode, 0.2 C to 10 C, and room temperature. The results are shown in FIG. 23(a) and FIG. 23(b). As a result, the discharge capacities of Examples 1 to 3 were greater than in Comparative Example 1 at 30 cycles or more and the discharge capacity retention rates of Examples 1 to 3 were also greater than in Comparative Example 1 at 30 cycles or more. In particular, in Comparative Example 1, the discharge capacity retention rate in cycles 30 to 35 was 55%, whereas in Example 1, the discharge capacity retention rate in cycles 30 to 35 was 61%. Therefore, it was understood that, under high potential conditions, the output characteristics of Example 1 were superior to Comparative Example 1 due to the formation of the oxyfluoride layer.

### [Cyclic Voltammetry Measurement Under High Potential Conditions]

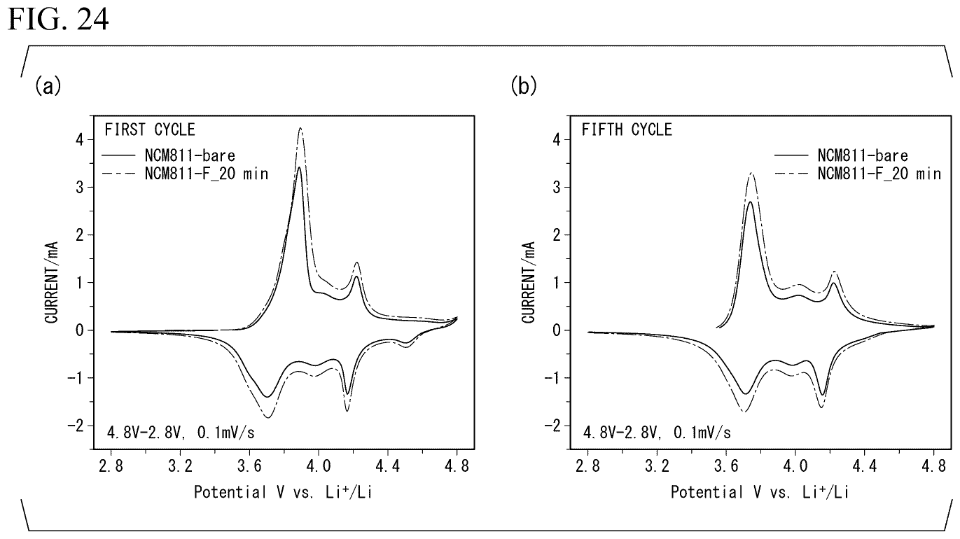

The coin half-cells prepared in Example 1 and Comparative Example 1 were subjected to cycle tests under the high potential conditions described above for 1 cycle and 5 cycles and measurements were performed using the cyclic voltammetry method (CV method). The results are shown in FIG. 24(a) and FIG. 24(b). In the figures, the horizontal axis shows the voltage (V, vs Li⁺/Li) applied to the solution and the vertical axis shows the output current density (mA). As a result, it was understood that, in Example 1, in both the first cycle and the fifth cycle, the peak current value increased more than in Comparative Example 1 due to the formation of the oxyfluoride layer. In addition, it was understood that, in Example 1, the current peak on the oxidation side was shifted to the higher potential side compared to Comparative Example 1 and the current peak on the reduction side was shifted to the lower potential side compared to Comparative Example 1.

### [Measurement of Ion Diffusion Coefficient]

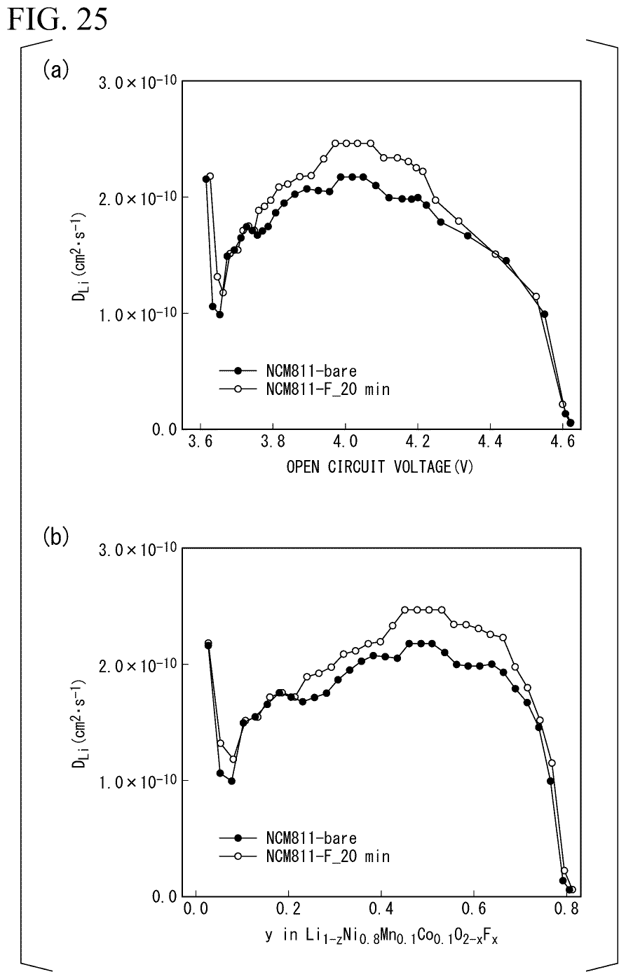

In order to investigate the effect of fluoride ion replacement on the changes in the lithium-ion diffusion coefficient within the active material during the charging process, galvanostatic intermittent titration technique (GITT) measurements were performed. The charge rate was set to 0.2 C and constant current pulse application and relaxation were repeated for 10 minutes each to charge from 2.8 V to 4.8 V FIG. 25(a) shows the lithium-ion diffusion coefficient (D_{Li}) with respect to the open circuit voltage obtained from the GITT measurement and FIG. 25(b) shows the lithium-ion diffusion coefficient with respect to the lithium composition (Li_{1-z}Ni_{0.8}Co_{0.1}Mn_{0.1}O₂₋ₓFₓ: 0<z<0.8, x=0.8).

As shown in FIG. 25(a), the lithium-ion diffusion coefficient of the positive-electrode active material subjected to fluoride ion replacement (also referred to below as NCM811-F_20 min) gradually increases from 3.6 V (z=0.1) and the difference from the lithium-ion diffusion coefficient of the positive-electrode active material not subjected to fluoride ion replacement (also referred to below as NCM811-bare) was the maximum at approximately 4.0 V (z=0.5). When carrying out further charging, the lithium-ion diffusion coefficient of NCM811-F_20 min suddenly decreased at approximately 4.2 V (z=0.6) and became equivalent to the lithium-ion diffusion coefficient of NCM811-bare at 4.4 V (z=0.7). In addition, as shown in FIG. 25(b), the lithium-ion diffusion coefficient of NCM811-F gradually increased from y=0.2 and the difference from the lithium-ion diffusion coefficient of NCM811-bare was the maximum at y=4.5. In addition, the lithium-ion diffusion coefficient of NCM811-F_20 min suddenly decreased at y=0.67 and became equivalent to the lithium-ion diffusion coefficient of NCM811-bare at y=0.7.

Changes in the lithium-ion diffusion coefficient during the charging process are caused by a diffusion barrier that changes depending on the lithium vacancy concentration in the positive-electrode active material, the charge balance of transition metal cations, and the like. It was confirmed that fluoride ion replacement increases the lithium-ion diffusion coefficient in the region of 3.6 V to 4.4 V and in the region of lithium composition 0.2<y<0.7.

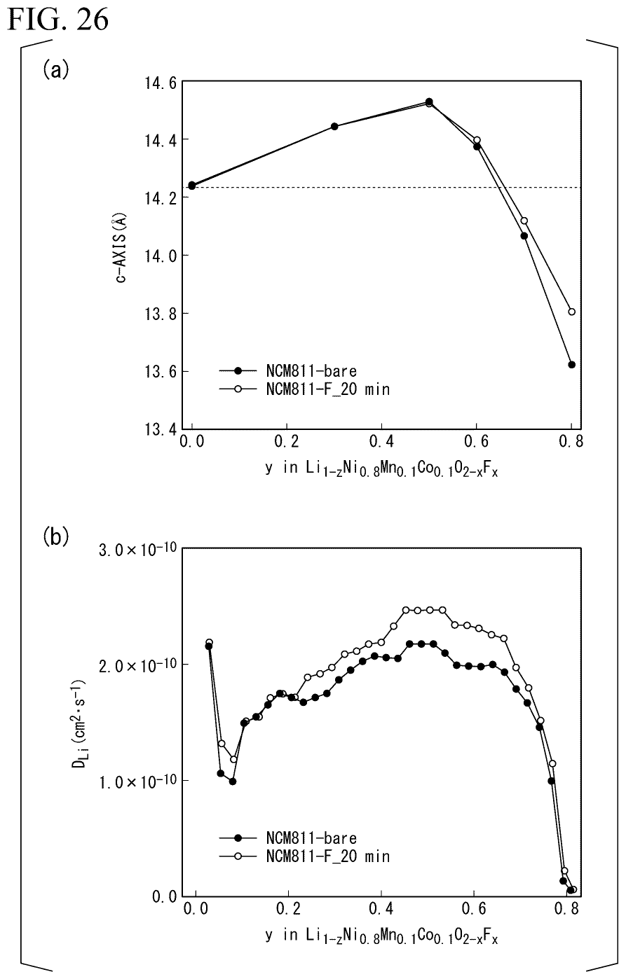

Next, in the charging process of NCM811-bare and NCM811-F_20 min, the correlation relationship was analyzed between the phase transition of the crystal structure from H1 phase (O3) to H2 phase (O3) and H3 phase (O1) and the lithium-ion diffusion coefficient. FIG. 26(a) shows the c-axis length with respect to the lithium composition obtained from the Ex-situ XRD measurement and FIG. 26(b) shows the lithium-ion diffusion coefficient with respect to the lithium composition (Li_{1-z}Ni_{0.8}Co_{0.1}Mn_{0.1}O₂₋ₓFₓ: 0<z<0.8, x=0.8) obtained from GITT measurement.

As shown in FIG. 26(a) and FIG. 26(b), in the region of 0<y<0.5 where the phase transition from the H1 phase to the H2 phase occurs, the lithium-ion diffusion coefficient also increased as the c-axis length showing the lattice volume change rate increased and, at z=0.5, where the c-axis length was maximum, the lithium-ion diffusion coefficient was also the maximum. In the region of z>0.5, where the phase transition occurred from the H2 phase to the H3 phase, the lithium-ion diffusion coefficient also decreased as the c-axis length decreased. From the above, it was clear that there is a correlation between the phase transition of the crystal structure (change in c-axis length) and the lithium-ion diffusion coefficient in the positive-electrode active material.

In addition, in the region of z>0.6 where the phase transition from the H2 phase to the H3 phase (contraction of c-axis length) was suppressed by the fluoride ion replacement, the lithium-ion diffusion coefficient of NCM811-F_20 min was larger than the lithium-ion diffusion coefficient of NCM811-bare in the region of 0.6<z<0.7. However, in the region of 0.7<z<0.8, no difference was observed in the lithium-ion diffusion coefficients of NCM811-bare and NCM811-F_20 min. Therefore, no correlation was confirmed between the suppression of contraction of the c-axis length (Li—O layer) in the high voltage region due to fluoride ion replacement and the lithium-ion diffusion coefficient.

### Example 4

### <Preparation of Coin Full-Cell>

A positive electrode can (positive electrode side case), a positive electrode for a lithium-ion secondary battery including the positive-electrode active material (NCM811-F_20 min) obtained in Example 1, a separator (Celgard (registered trademark), #2400), a gasket, a negative electrode (graphite), a spacer, a spring, and a negative electrode can (negative electrode side case) were laminated in this order, 140 μL of an electrolytic solution (1M LiPF₆ EC/DMC (1:2) VC (vinylene carbonate 1.0% by mass) was stored in the inner part of the positive electrode can, and 70 μL of the same electrolytic solution was stored inside the negative electrode can to prepare a coin full-cell. Graphite was used for the negative electrode.

### Example 5

A coin full-cell was prepared in the same manner as in Example 4, except that the positive electrode for a lithium-ion secondary battery including the positive-electrode active material (NCM811-F_30 min) obtained in Example 2 was used and the coin half-cell was changed to a coin full-cell.

### Comparative Example 2

A coin full-cell was prepared in the same manner as in Example 4, except that the positive electrode for a lithium-ion secondary battery including the positive-electrode active material (NCM811-bare) obtained in Comparative Example 1 was used and the coin half-cell was changed to a coin full-cell.

The obtained Examples 4 to 5 and Comparative Example 2 were measured and evaluated by the following methods.

### [XPS Analysis (2)]

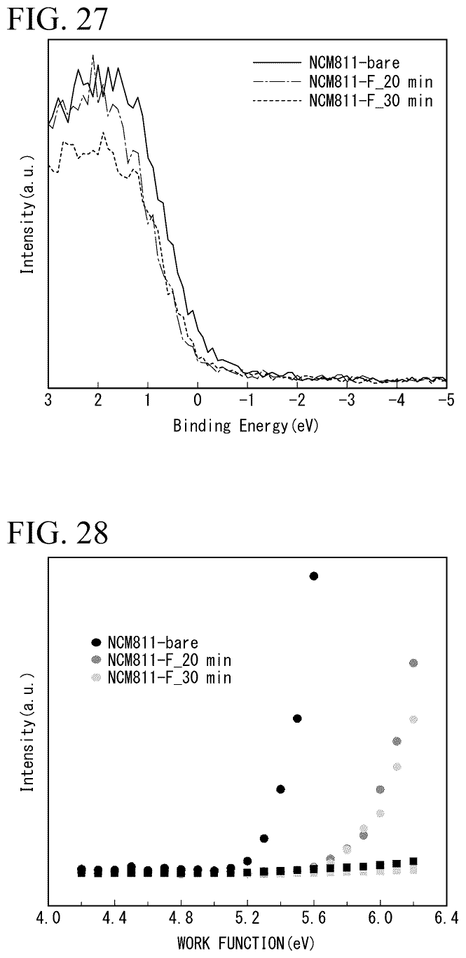

XPS analysis of the positive-electrode active material was performed under the same conditions as described in the case of the coin half-cell and changes in the valence band spectrum before and after fluoride ion replacement were investigated. The results are shown in FIG. 27.

As a result, in Examples 4 to 5 of the coin full-cell, compared to Comparative Example 2, the rising position of the spectrum shifted to the high energy side by approximately 0.4 eV due to the nickel-fluorine bond. From this result, it was observed that the binding energy of the outermost shell electrons increased due to the fluoride ion replacement, which suggested that the energy level of the valence band decreased due to the fluoride ion replacement.

### [UPS Measurement]

UPS measurement of the surface of the positive-electrode active material was performed under the same conditions as described in the case of the coin half-cell and the work function of the positive-electrode active material was evaluated. The results are shown in FIG. 28.

As a result, in Examples 4 to 5 of the coin full-cell, compared to Comparative Example 2, the rising position of the spectrum shifted to the high energy side. In addition, the work function of the Comparative Example was 5.16 eV, while the work functions of Examples 4 and 5 were 5.49 eV (A=0.33 eV) and 5.57 eV (A=0.41 eV). Therefore, an increase in the work function due to fluoride ion replacement was observed, which suggested a decrease in the Fermi level due to the fluoride ion replacement.

### [Cycle Characteristic Evaluation]

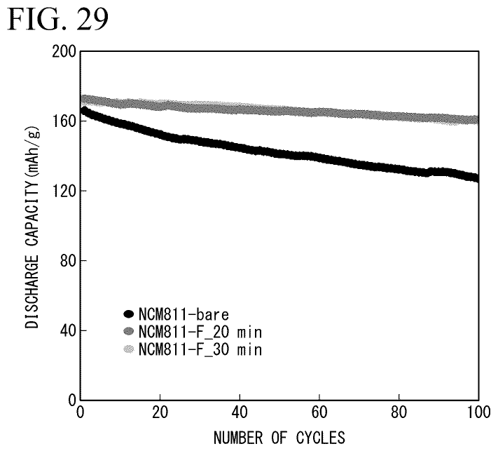

The cycle characteristics were evaluated at 200 cycles under the same conditions as described in the case of the coin half-cell. The results are shown in FIG. 29.

From these results, the initial discharge capacities of Examples 4 and 5 were 172.7 mAh/g and 171.0 mAh/g, and the initial discharge capacity of Comparative Example 2 was 165.8 mAh/g. The reason why the initial discharge capacities of Examples 4 and 5 were larger than the discharge capacity of Comparative Example 2 is considered to be that the consumption of lithium-ions due to CEI generation during aging was reduced. In addition, the initial discharge capacity of Example 5 was smaller than the initial discharge capacity of Example 4. This is due to the large amount of LiF deposited as a by-product of lithium-ions being consumed in the active material during fluoride ion replacement on the surface.

The discharge capacities of Examples 4 and 5 after 100 cycles were 160.7 mAh/g and 160.0 mAh/g and the discharge capacity of Comparative Example 2 after 100 cycles was 127.0 mAh/g. In addition, the discharge capacity retention rates of Examples 4 and 5 after 100 cycles were 93.0% and 93.6% and the discharge capacity retention rate of Comparative Example 2 after 100 cycles was 76.6%. From this result, it was observed that the cycle characteristics of NCM811 were improved by fluoride ion replacement.

In contrast, the significant decrease in discharge capacity in Comparative Example 2 is considered to be due to the thick CEI generated on the surface of the positive electrode. The thick CEI acts as a resistance layer, thus inhibiting lithium-ion diffusion and decreasing discharge capacity. Alternatively, it is considered that the CEI generated on the surface of the positive electrode in Comparative Example 2 was unstable and lithium-ions were consumed by continuous decomposition of the electrolytic solution, resulting in a decrease in the discharge capacity.

### [Impedance Analysis]

AC impedance measurements were carried out to investigate the effect of fluoride ion replacement on the resistance of the electrode/electrolytic solution interface.

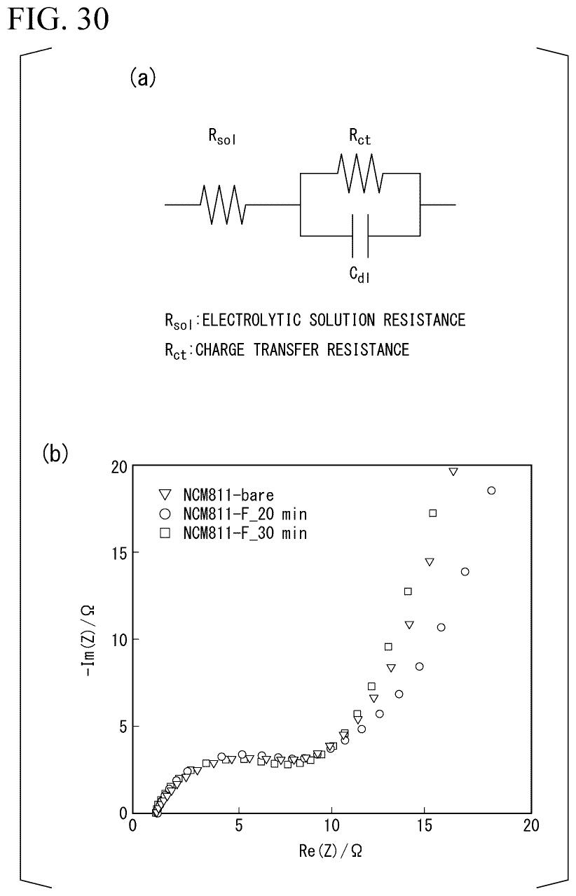

Under the same conditions as described in the case of the coin half-cell, the insertion and desorption of Li into and from the positive electrode by charging and discharging was performed in one cycle and the impedance of the coin full-cell after one cycle was measured. FIG. 30(a) shows the equivalent circuit model used for the frequency response analysis and FIG. 30(b) shows a Nyquist plot obtained from the full coin cell before the cycle test (open circuit voltage).

As a result, an arc corresponding to one impedance component was confirmed in the frequency range of 200 kHz to 850 Hz. It is possible to attribute this arc to the resistance of the lithium-ion insertion and removal (charge transfer) between the electrolytic solution and the positive electrode (negative electrode) active material particles. The frequency response ranges of the resistance components of the positive electrode and negative electrode were close and it was not possible to separate the resistance components.

In addition, Table 5 shows the resistance values of each resistance component (Rₛₒₗ, R_{ct}). The charge transfer resistances of Examples 4 and 5 exhibited values equivalent to the values of Comparative Example 2 and no fluoride ion replacement effect was observed on the charge transfer resistance before the cycle test.

TABLE 5

| | Rₛₒₗ | R_{ct} |
|---|---|---|
| | (Ω) | (Ω) |
| Comparative | 1.1 | 8.5 |
| Example 2 | | |
| Example 4 | 1.2 | 8.4 |
| Example 5 | 1.1 | 8.3 |

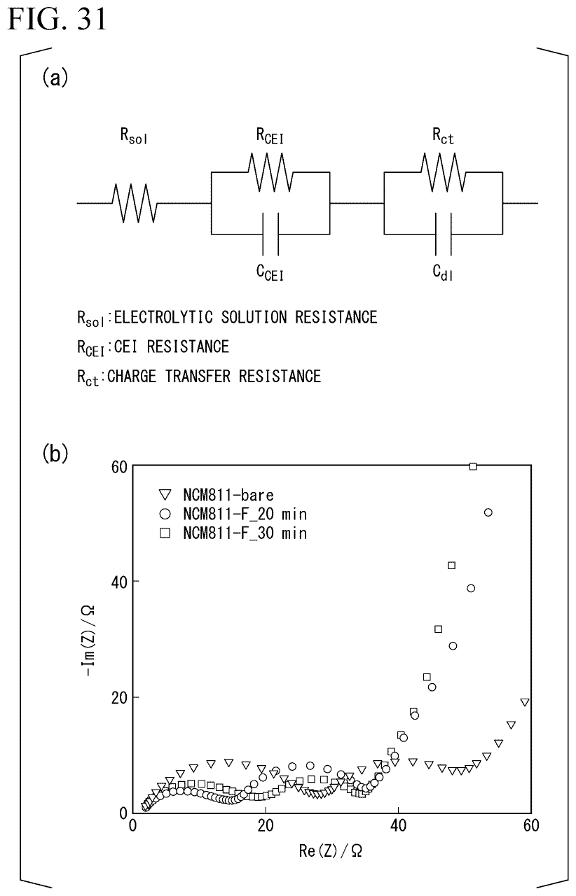

Next, the impedance of the coin full-cell after 100 cycles was measured under the same conditions described in the case of the coin half-cell. FIG. 31(a) shows an equivalent circuit model used for frequency response analysis and FIG. 31(b) shows a Nyquist plot obtained from the full coin cell after 100 cycles.

As a result, arcs corresponding to two impedance components were confirmed in the frequency ranges of 200 kHz to 121 Hz and 120 Hz to 0.35 Hz. The arc on the high frequency side derives from the resistance of lithium-ion diffusion in the CEI layer formed on the surfaces of the positive electrode and negative electrode. The arc on the low frequency side derives from lithium-ion insertion and removal (charge transfer) resistance between the CEI layer and the positive electrode (negative electrode) active material particles. The frequency response ranges of each resistance component of the positive electrode and negative electrode were close and it was not possible to separate the resistance components.

In addition, Table 6 shows the resistance values of each resistance component (Rₛₒₗ, R_{CEI}, R_{ct}). The CEI resistances of Examples 4 and 5 exhibited lower values than the CEI resistance of Comparative Example 2. This result suggests thinning of the CEI layer and improvement of lithium-ion conductivity within the CEI layer due to the fluoride ion replacement. Therefore, it is considered that decomposition of the electrolytic solution on the positive electrode surface of Examples 4 and 5 was suppressed. In addition, the CEI resistance of Example 5 was greater than the CEI resistance of Example 4. This is due to the large amount of LiF deposited as a by-product due to the solid solubility limit during fluoride ion replacement on the surface. LiF on the particle surface becomes a resistance layer that inhibits lithium-ion diffusion.

The charge transfer resistance was increased in the order of Comparative Example 2>Example 4>Example 5. The above suggests that the larger the charge transfer resistance is, the more serious the deterioration of the electrode surface is, such as the reduction of lithium sites in the active material and the reduction of lithium-ion diffusion paths. Therefore, in Examples 4 and 5, it is considered that the structure of the crystal surface of NCM811 was stabilized by the fluoride ion replacement and deterioration of the positive-electrode active material was suppressed.

TABLE 6

| | Rₛₒₗ | R_{CEI} | R_{ct} |
|---|---|---|---|
| | (Ω) | (Ω) | (Ω) |
| Comparative | 1.5 | 27.9 | 25.8 |
| Example 2 | | | |
| Example 4 | 1.3 | 13.2 | 23.8 |
| Example 5 | 1.4 | 16.9 | 17.6 |

### [XPS Analysis (3)]

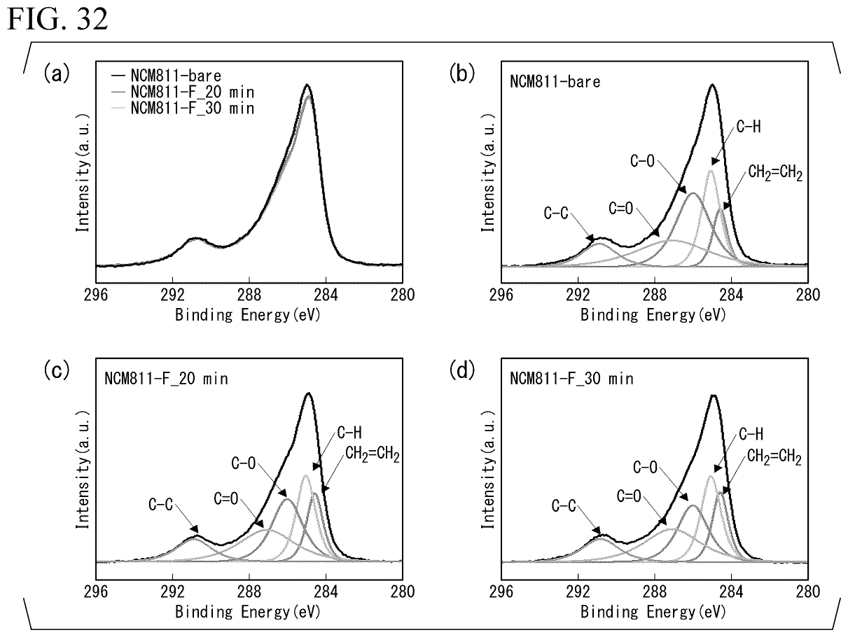

The chemical state of the positive electrode surface in Examples 4 and 5 and Comparative Example 2 after the cycle test was analyzed by X-ray photoelectron spectroscopy (XPS). FIGS. 32(a) to (d) show the XPS-C1s core level spectra. FIG. 32(a) shows the spectra of Examples 4 and 5 and Comparative Example 2 before waveform separation and FIG. 32(b) to 32(d) show the spectra of Comparative Example 2, Example 4, and Example 5 after waveform separation.

As a result of waveform separation of the spectra, it was possible to make attributions using C—C (284.6 eV), C—H (285.0 eV), C—O (285.8 eV), O—C—O (286.4 eV), C═O (287.4 eV), —CH₂—OCO₂Li (287.8 eV), Li₂CO₃ (289.2 eV), and CH₂—CF₂ (290.8 eV). Table 7 shows the area ratio of each peak to the total area of the spectrum. These peaks derive from the decomposition products of organic solvent molecules (EC and DMC).

Among the above, the 286.0 eV peak attributed to C—O and O—C—O derives from polymer-based decomposition products such as polyethylene oxide. Polymer-based decomposition products are produced by chain reactions of organic solvent molecules (EC and DMC). In Examples 4 and 5, the area ratios of the peaks attributed to C—O and O—C—O were 9.8% and 9.0% and the area ratio of the same peaks in Comparative Example 2 was 15.4%. The above suggests that the decomposition of the polymer-based decomposition products was suppressed by fluoride ion replacement.

In addition, the 287.6 eV peak attributed to C═O, —CH₂—OCO₂Li, and Li₂CO₃ derives from carbonate-based decomposition products such as inorganic carbonates. In Examples 4 and 5, the area ratios of the peaks attributed to C═O, —CH₂—OCO₂Li, and Li₂CO₃ were 8.9% and 9.3% and the area ratio of the same peaks in Comparative Example 2 was 11.4%. The above suggests that the decomposition of carbonate-based decomposition products is suppressed by fluoride ion replacement. Carbonate-based decomposition products are reported to act as a resistance layer for lithium-ion diffusion, causing a decrease in battery capacity. In practice, the CEI resistance after the cycle test increased in the order of Example 4, Example 5, and Comparative Example 2 (Example 4<Example 5<Comparative Example 2) and the discharge capacity decreased in the order of Example 4, Example 5, and Comparative Example 2 (Example 4>Example 5>Comparative Example 2). From the above analysis results, in Examples 4 and 5, it was confirmed that the decomposition of organic solvent molecules was suppressed by the fluoride ion replacement.

Furthermore, when the sums of the peak area ratios of C—O and C═O is 100% and the peak area ratios of C—O and C═O ((C—O):(C═O)) are compared, the ratios were 52.7%: 47.3% in Example 4, 48.7%: 51.3% in Example 5, and 57.5%: 42.5% in Comparative Example 2. From this result, it was confirmed that, in Examples 4 and 5, the formation of carbonate-based decomposition products was promoted more than polymer-based decomposition products. This is considered to be because the reactivity with the electrolytic solution changed due to a decrease in the electron-donating property of the electrode surface due to fluoride ion replacement.

TABLE 7

| | Area ratio (%) | | | | |
|---|---|---|---|---|---|
| | C—C | C—H | C—O | C═O | CH₂—CF₂ |
| Comparative | 4.4 | 9.3 | 15.4 | 11.4 | 4.2 |
| Example 2 | | | | | |
| Example 4 | 5.7 | 8.5 | 9.8 | 8.9 | 4.1 |
| Example 5 | 5.8 | 8.8 | 9.0 | 9.3 | 4.3 |

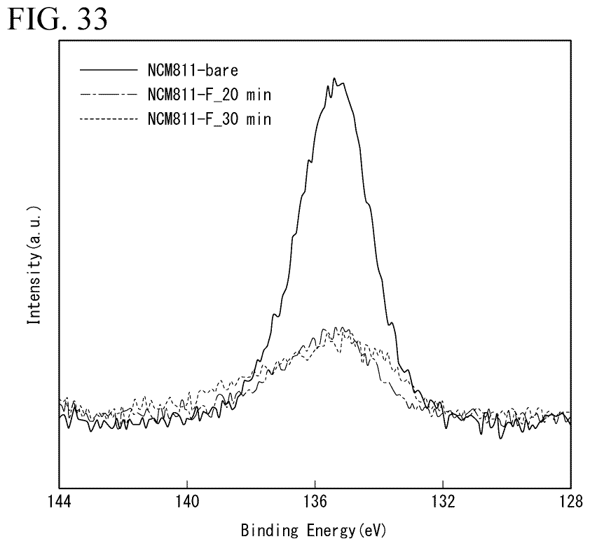

In addition, FIG. 33 shows the XPS-P2p core level spectrum. This spectrum is attributed to P—O (134.4 eV), LiₓPO_{y}F_{z} (135.4 eV), and LiₓPF_{y} (136.0 eV), and is derived from the decomposition product of lithium salt LiPF₆. The detection intensity was low and waveform separation was not possible. The area ratios of the spectra in Examples 4 and 5 were 0.46% and 0.44% and the area ratio of the same spectrum in Comparative Example 2 was 1.63%. This result suggested that LiPF₆ decomposition was suppressed by the fluoride ion replacement.

### Example 6

### <Manufacturing of Positive Electrode for Lithium-Ion Secondary Battery>

Oxide ions on the surface of a LiNi_{0.8}Co_{0.1}Mn_{0.1}O₂ crystal (manufactured by Hohsen Corp.) were replaced with fluoride ions by a gas-solid reaction using xenon difluoride (manufactured by FUJIFILM Wako Pure Corporation). 1.2 g of LiNi_{0.8}Co_{0.1}Mn_{0.1}O₂ powder and 0.096 g of xenon difluoride (molar ratio 1:0.046) were weighed. LiNi_{0.8}Co_{0.1}Mn_{0.1}O₂ powder was filled in a 2 mL alumina sample container (manufactured by Nagano Keiki Co., Ltd.) and xenon difluoride was filled in a φ5×2.5 mm alumina sample container (manufactured by Rigaku Corp.). The two alumina sample containers filled with samples were placed in a sealed container and left to stand in a glove box. The standing time was 90 minutes. Solid xenon difluoride was vaporized to generate gaseous xenon and fluorine radicals, and the generated fluorine radicals reacted with LiNi_{0.8}Co_{0.1}Mn_{0.1}O₂ particles to obtain LiNi_{0.8}Co_{0.1}Mn_{0.1}O₂₋ₓFₓ particles in which the surface was replaced with fluoride ions.

Next, in order to expand the fluoride ion replacement layer on the particle surfaces into the inner part of the particles, LiNi_{0.8}Co_{0.1}Mn_{0.1}O₂₋ₓFₓ powder fluorinated for 90 minutes using an ultra-precision small electric furnace (FT-01X, manufactured by Full-Tech Corp.) was heat treated at 300° C. for 17 minutes. Other heat treatment conditions were as shown in Table 8.

A positive electrode for a lithium-ion secondary battery was obtained in the same manner as in Example 1 using the obtained positive-electrode active material (NCM811-F_90 min_300° C.).

### <Preparation of Coin Half-Cell>

A positive electrode for a lithium-ion secondary battery was prepared and a coin half-cell was prepared in the same manner as in Example 1, except that a positive-electrode active material (NCM811-F_90 min_300° C.) was used.

### Example 7

A positive electrode for a lithium-ion secondary battery including a positive-electrode active material (NCM811-F_90 min 500° C.) was prepared and a coin half-cell was prepared in the same manner as in Example 1, except that the obtained LiNi_{0.8}Co_{0.1}Mn_{0.1}O₂₋ₓFₓ powder was heat treated at 500° C. for 15 minutes.

### Example 8

A positive electrode for a lithium-ion secondary battery including a positive-electrode active material (NCM811-F_90 min_1000° C.) was prepared and a coin half-cell was prepared in the same manner as in Example 1, except that the obtained LiNi_{0.8}Co_{0.1}Mn_{0.1}O₂₋ₓFₓ powder was heat treated at 1000° C. for 10 minutes.

TABLE 8

| | | Heating | Holding | Holding |
|---|---|---|---|---|
| | Heating rate | time | temperature | time |
| | (° C./min) | (min) | (° C.) | (min) |
| Example 6 | 100 | 3 | 300 | 17 |
| Example 7 | 100 | 5 | 500 | 15 |
| Example 8 | 100 | 10 | 1000 | 10 |

The obtained Examples 6 to 8 were measured and evaluated by the following method.

### [External Appearance of Positive-Electrode Active Material]

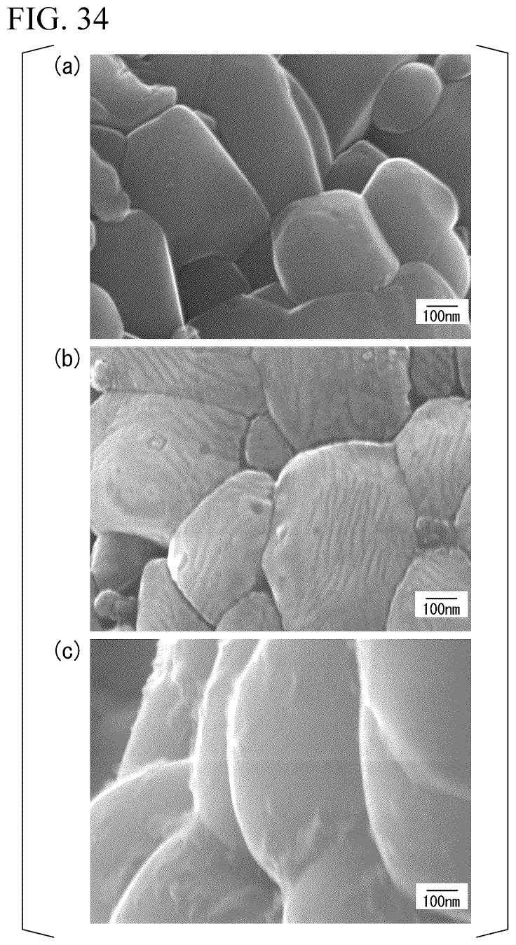

The positive-electrode active material was observed using a field emission scanning electron microscope (FE-SEM). As a result, it was confirmed that, in Example 6 (FIG. 34(a)), the fine particle deposits (refer to FIG. 6(c)) deposited on the surface of the positive-electrode active material disappeared and, in Example 7 (FIG. 34(b)), a striped uneven structure was formed on the surface of the positive-electrode active material. This striped uneven structure is considered to be formed by the fluoride ion replacement layer. In addition, in Example 8 (FIG. 34(c)), it was confirmed that the striped uneven structure formed on the surface of the positive-electrode active material disappeared. It is considered that the striped uneven structure disappeared due to the decrease in the fluoride ion concentration on the outermost surface and the surface energy of the fluoride ion replacement layer becoming close to the surface energy of the lithium metal composite oxide.

### [Impedance Analysis]

In the same manner as the coin half-cell, the insertion and desorption of Li into and from the positive electrode by charging and discharging the coin full-cell was performed in one cycle and the impedance of the coin full-cell after one cycle was measured. Using the equivalent circuit model used for frequency response analysis and setting the resistance of the electrolytic solution as Rₛₒₗ, the resistance of the CEI layer (coating layer) as R_{CEI}, and the charge transfer resistance between the CEI layer and the core particle as R_{ct}, each value was determined (refer to FIG. 14(a)). The results are shown in Table 9. As a result, it was understood that the CEI layer resistance R_{CEI} in a case of using the positive-electrode active material (NCM811-F_20 min, NCM811-90 min_500° C.) subjected to fluoride ion replacement was smaller than the CEI layer resistance R_{CEI} in a case of using the positive-electrode active material (NCM811-bare) not subjected to fluoride ion replacement (Comparative Example 2). In addition, it was understood that the charge transfer resistance R_{ct} in a case of using the positive-electrode active material (NCM811-F_20 min, NCM811-F_90 min_500° C.) was smaller than the charge transfer resistance R_{ct} in a case of using the positive-electrode active material (NCM811-bare) (Comparative Example 2).

TABLE 9

| | Rₛₒₗ | R_{CEI} | R_{ct} |
|---|---|---|---|
| | (Ω) | (Ω) | (Ω) |
| NCM811-bare | 2.6 | 15.2 | 153.7 |
| NCM811-F_20 min | 1.6 | 4.7 | 88.2 |
| NCM811-F_90 min_500° C. | 1.7 | 11.2 | 81.9 |

In addition, using the equivalent circuit model used for frequency response analysis and setting the electrolytic solution resistance as R₀, the first component of the CEI resistance as R₁, the second component as R₂, the desolvation resistance of the charge transfer resistance as R₃, and the insertion and removal resistance as set as R₄, each value was determined. The results are shown in Table 10. As a result, it was understood that the sum of the first and second components R₁ and R₂ of the CEI resistance in a case of using a positive-electrode active material (NCM811-F_20 min, NCM811-_90 min_500° C.) subjected to fluoride ion replacement was smaller than the sum of the first and second components R₁ and R₂ of the CEI resistance in a case of using a positive-electrode active material (NCM811-bare) not subjected to fluoride ion replacement (Comparative Example 2). In addition, it was understood that the sum of the desolvation resistance R₃ and the insertion and removal resistance R₄ in a case of using the positive-electrode active material (NCM811-F_20 min, NCM811-90 min_500° C.) was smaller than the sum of the desolvation resistance R₃ and the insertion and removal resistance R₄ in a case of using the positive-electrode active material (NCM811-bare) (Comparative Example 2).

TABLE 10

| | R₀ | R₁ | R₂ | R₃ | R₄ |
|---|---|---|---|---|---|
| | (Ω) | (Ω) | (Ω) | (Ω) | (Ω) |
| NCM811-bare | 2.6 | 3.0 | 12.2 | 110.3 | 43.4 |
| NCM811-F_20 min | 1.6 | 1.4 | 3.3 | 66.6 | 21.6 |
| NCM811-F_90 min_500° C. | 1.7 | 2.4 | 8.8 | 65.2 | 16.7 |

### [Measurement of Ion Diffusion Coefficient]

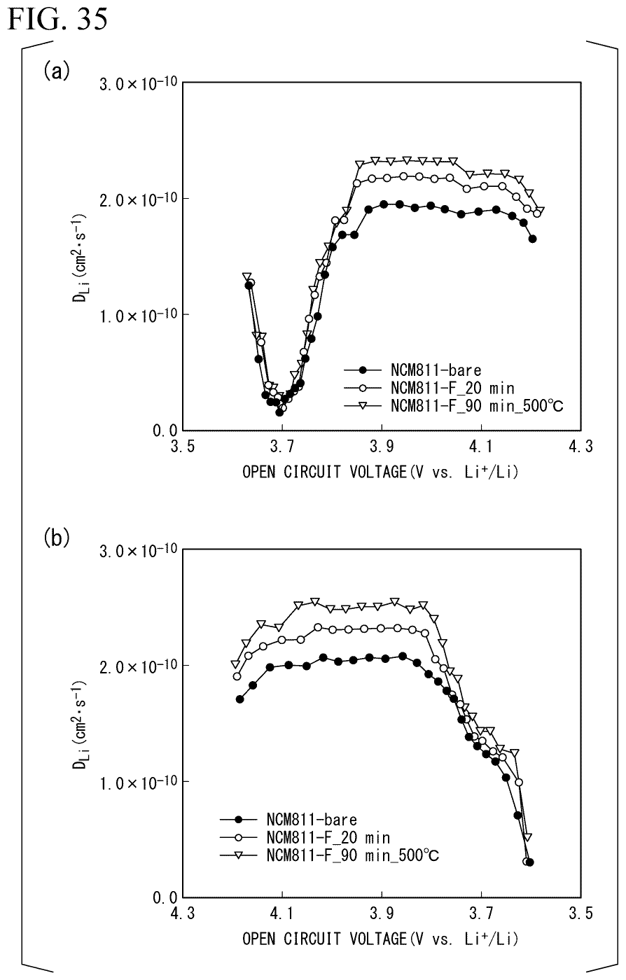

Galvanostatic intermittent titration technique (GITT) measurement of the coin full-cell was performed in the same manner as for the coin half-cell. The charge rate was set to 0.2 C and constant current pulse application and relaxation were repeated for 10 minutes each to carry out charging from 3.6 V to 4.2 V. In addition, the discharge rate was set to 0.2 C and constant current pulse application and relaxation were repeated for 10 minutes each to carry out discharging from 4.2 V to 3.6 V. FIG. 35(a) shows the lithium-ion diffusion coefficient (D_{Li}) during charging with respect to the open circuit voltage obtained from the GITT measurement and FIG. 35(b) shows the lithium-ion diffusion coefficient (D_{Li}) during discharging.

As shown in FIG. 35(a), the lithium-ion diffusion coefficient of the positive-electrode active material (NCM811-F_20 min, NCM811-F_90 min_500° C.) subjected to fluoride ion replacement was larger than the lithium-ion diffusion coefficient of the positive-electrode active material (NCM811-bare) not subjected to fluoride ion replacement in the region of 3.7 V to 4.2 V, in particular, in the region of 3.8 V to 4.2 V.

Changes in the lithium-ion diffusion coefficient during the charging process are caused by a diffusion barrier that changes depending on the lithium vacancy concentration in the positive-electrode active material, the charge balance of transition metal cations, and the like. It was confirmed that the lithium-ion diffusion coefficient increased in the 3.8 V to 4.2 V region due to the heat treatment after fluoride ion replacement.

Furthermore, as shown in FIG. 35(b), the lithium-ion diffusion coefficient of the positive-electrode active material (NCM811-F_20 min, NCM811-F_90 min_500° C.) subjected to fluoride ion replacement was larger than the lithium-ion diffusion coefficient of the positive-electrode active material (NCM811-bare) not subjected to fluoride ion replacement in the region of 4.2 V to 3.6 V, in particular, in the region of 4.2 V to 3.8 V.

Changes in the lithium-ion diffusion coefficient during the discharge process are due to changes in the lithium-ion removal reaction mechanism. Lithium-ion desorption reactions include solid solution reactions (where the lithium composition changes continuously) and two-phase coexistence reactions (where two states with different lithium compositions are formed) and the former is preferable from the viewpoint of lithium-ion diffusivity and suppressing lattice distortion. In this Example, it is presumed that the ion diffusion coefficient increased because the solid solution reaction region was expanded by the fluoride ion replacement. It was confirmed that the heat treatment after fluoride ion replacement increased the lithium-ion diffusion coefficient in the 4.2 V to 3.6 V region.

### [Measurement of Composition Ratio in Thickness Direction of Fluoride Layer]

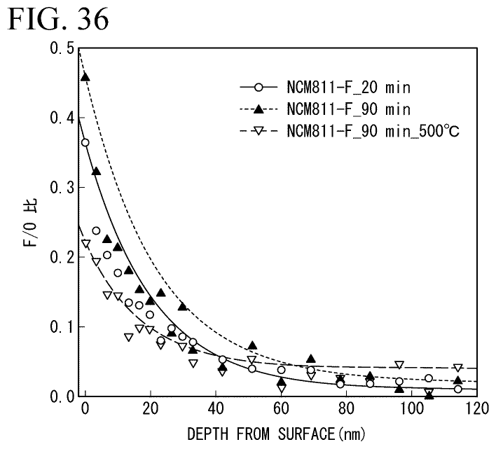

In the same manner as the coin half-cell, using the XPS described above, changes in the concentration of the fluorine atoms with respect to the oxygen atoms were measured in relation to the direction from the outer surface to the inner part of the positive-electrode active materials in Example 7. The results are shown in FIG. 36. The “DEPTH FROM SURFACE” on the horizontal axis in FIG. 36 is an SiO₂-converted value. In addition, the measurement results are also shown for a coin half-cell manufactured using the positive-electrode active material (NCM811-F_90 min) used in Example 3.

As shown in FIG. 36, in a case of using a positive-electrode active material (NCM811-F_90 min_500° C.) subjected to fluoride ion replacement (Example 7), it was understood that the concentration ratio of fluorine atoms to oxygen atoms in the fluoride layer (F/O ratio) was reduced in the range of 0 to 60 nm compared to the case of using a positive-electrode active material (NCM811-F_90 min) that was not subjected to heat treatment. In contrast, in the range of 60 nm or more, it was understood that the F/O ratio was higher in a case of using the positive-electrode active material (NCM811-F_90 min_500° C.) than in a case of using the positive-electrode active material (NCM811-F_90 min).

In addition, in a case where the positive-electrode active material (NCM811-F_90 min_500° C.) was used, the F/O ratio was 0.04 or more and 0.06 or less even in the range of 50 nm or more and 100 nm or less; however, in a case of using the positive-electrode active material (NCM811-F_20 min), the F/O ratio was 0.01 or more and 0.04 or less in the same range. In addition, in a case where the positive-electrode active material (NCM811-F_90 min) was used, the F/O ratio was 0.02 or more and 0.07 or less in the same range.

From these results, it was understood that the heat treatment after fluoride ion replacement caused the fluorine atoms near the surface of the positive-electrode active material to further diffuse into the inner part. In addition, since the decrease in the F/O ratio in the depth direction was suppressed by the heat treatment after fluoride ion replacement, it was understood that it was possible to control the concentration gradient of the F/O ratio according to the presence or absence of the heat treatment.

### REFERENCE SIGNS LIST

10: Lithium-ion secondary battery
1: Positive electrode
1a: Positive electrode current collector
1b: Positive-electrode active material-containing layer
2: Negative electrode
2a: Negative electrode current collector
2b: Negative electrode active material-containing layer
3: Electrolyte
4: Positive electrode side case
5: Negative electrode side case
6: Gasket
7: Separator
11: Positive-electrode active material for a lithium-ion secondary battery
11a: Core particle
11b: Fluoride layer

1. A positive-electrode active material for a lithium-ion secondary battery comprising:
a core particle formed of a lithium metal composite oxide; and
a fluoride layer which coats at least part of the core particle and is formed of a fluoride of the lithium metal composite oxide,
wherein the lithium metal composite oxide is represented by LiNiₖCoₗMnₘO₂ (k+1+m=1, k≥0.6), and
the fluoride of the lithium metal composite oxide is represented by Li_{1-z}NiₖCoₗMnₘO₂₋ₓFₓ (k+l+m=1, k≥0.6, z≤0.62, 0<x≤1).

2. The positive-electrode active material for a lithium-ion secondary battery according to claim 1,
wherein the fluoride layer contains lithium fluoride.

3. The positive-electrode active material for a lithium-ion secondary battery according to claim 1,
wherein a concentration ratio of fluorine atoms to oxygen atoms in the fluoride layer decreases from an outer surface toward an inner part of the positive-electrode active material for a lithium-ion secondary battery.

4. The positive-electrode active material for a lithium-ion secondary battery according to claim 1,
wherein the fluoride of the lithium metal composite oxide has a layered rock salt-type structure, and
fluorine atoms are coordinated between adjacent transition metal layers of the layered rock salt-type structure.

5. The positive-electrode active material for a lithium-ion secondary battery according to any one of claim 1,
wherein an atomic concentration ratio of fluorine atoms to oxygen atoms in the fluoride layer is 0.03 or more and 0.5 or less in a depth range of 0 to 50 nm from the outer surface of the positive-electrode active material for a lithium-ion secondary battery.

6. The positive-electrode active material for a lithium-ion secondary battery according to claim 5,
wherein the atomic concentration ratio of fluorine atoms to oxygen atoms in the fluoride layer is 0.01 or more and 0.08 or less in a depth range of 50 to 100 nm from the outer surface of the positive-electrode active material for a lithium-ion secondary battery.

7. The positive-electrode active material for a lithium-ion secondary battery according to any one of claim 1,
wherein the lithium metal composite oxide is represented by LiNi_{0.8}Co_{0.1}Mn_{0.1}O₂, and the fluoride of the lithium metal composite oxide is represented by Li_{1-z}Ni_{0.8}Co_{0.1}Mn_{0.1}O₂₋ₓFₓ (z≤0.62, 0<x≤1).

8. A positive electrode for a lithium-ion secondary battery comprising:
a positive electrode current collector; and
a positive-electrode active material-containing layer containing the positive-electrode active material for a lithium-ion secondary battery according to any one of claim 1, which is provided on the positive electrode current collector.

9. A lithium-ion secondary battery comprising:
the positive electrode for a lithium-ion secondary battery according to claim 8;
a negative electrode; and
an electrolyte.

10. A method for manufacturing a positive-electrode active material for a lithium-ion secondary battery, the method comprising:
a step of placing a rare gas fluoride and a lithium metal composite oxide in a sealed space and forming a fluoride layer formed of a fluoride of the lithium metal composite oxide on the lithium metal composite oxide.

11. The method for manufacturing a positive-electrode active material for a lithium-ion secondary battery according to claim 10, further comprising:
a step of heat treating the lithium metal composite oxide on which the fluoride layer is formed after the step of forming the fluoride layer.

12. The method for manufacturing a positive-electrode active material for a lithium-ion secondary battery according to claim 10,
wherein the lithium metal composite oxide on which the fluoride layer is formed is heat treated at 300° C. to 1000° C. for 3 hours to 10 hours.
